(19) United States
(12) Patent Application Publication
(10) Pub. No.: US 2022/0018065 A1
(43) Pub. Date: Jan. 20, 2022

(54) METHOD OF PRODUCING HOLOCELLULOSE AND PAPER STRENGTH AGENT, PROCESS FOR THE PRODUCTION OF PAPER, THE PAPER PRODUCED AND USE OF THE PRODUCED PAPER

(71) Applicants: RISE INNVENTIA AB, Stockholm (SE); RISE RESEARCH INSTITUTES OF SWEDEN AB, Borås (SE)

(72) Inventors: Paul KROCHAK, Stockholm (SE); Klas JOHANSSON, Järfälla (SE); Fredrik BERTHOLD, Djursholm (SE); Eric JOHANSSON SALAZAR-SANDOVAL, Bengtsfors (SE); Erika TÖNNERFORS, Södertälje (SE); Frédéric POUYET, Stockholm (SE)

(21) Appl. No.: 17/297,781

(22) PCT Filed: Nov. 15, 2019
(86) PCT No.: PCT/SE2019/051164

§ 371 Date: May 27, 2021

(30) Foreign Application Priority Data
Nov. 29, 2018 (SE) 1851488-5
Nov. 29, 2018 (SE) 1851489-3

(51) Int. Cl. D21C 3/00; D21C 3/02; D21C 3/24; D21C 3/26; D21H 11/18; D21H 21/18; D21H 17/29; D21H 17/45

(52) U.S. Cl. CPC D21C 3/003; D21C 3/02; D21C 3/24; D21H 17/45; D21H 11/18; D21H 21/18; D21H 17/29; D21C 3/26

(57) ABSTRACT

The present invention relates to a method of producing holocellulose fibres by treating a wood-based raw material with an organic peroxide, wherein the method comprises charging the organic peroxide continuously to the wood-based raw material during the treatment and/or charging the organic peroxide to the wood-based raw material in at least two separate steps with an intermediate alkaline treatment step. Additionally, a process for the production of paper comprising the steps of preparing a papermaking stock comprising an aqueous pulp slurry comprising cellulosic fibres and having a fibre consistency of from 0.1 to 40% by weight, wherein the cellulosic fibres comprise or consist of holocellulose fibres, and wherein the amount of the wood-based holocellulose fibres is from 0.5 to 100% by weight, based on the total weight of the stock; providing the stock to a wire and form a web; dewatering the web; and drying the web is claimed. By the method affordable way to produce holocellulose fibres usable in the process to provide paper with high strength is provided, while effective dewatering can be obtained during the manufacturing process.

### TECHNICAL FIELD

The present invention relates to a method of producing holocellulose, a method of producing a paper strength agent, a process for the production of paper, the paper produced by the process and to uses of the produced paper as defined in the appended claims.

### BACKGROUND ART

Wood mainly comprises cellulose, hemicellulose and lignin. The word holocellulose is used to describe a material from lignocellulosic origin that contains hemicelluloses and celluloses, after removal of lignin and extractives.

Paper, tissue and packaging materials based on wood fibres have been historically used for e.g. printing, hygienic and packaging purposes. Paper as packaging material has been used to provide mechanical and/or chemical protection for packaged goods. There is a growing demand to produce paper with higher resource efficiency, with for example decreased usage of fibre raw material, chemical additives and energy, and with effective production processes. There is also an increasing demand for lightweight paper materials with good mechanical strength, for example to ensure sufficient protection of packaged goods. Additionally, there is a desire to reduce transports required for the production of paper and therefore it is desirable to use raw materials available locally. Further, there is desire to use raw materials that are environmentally friendly and which are not principally aimed for global food production.

Known methods to decrease the amount of fibre raw material, while maintaining the strength of the paper, have involved for example use of different additives to increase the strength of the paper. However, the strength additives may have a negative impact on drainage during the papermaking process, which means that it may be more difficult to drain a fibre web in a paper machine. Difficult draining in the papermaking process may result in a decreased production capacity and higher energy demand, which is highly undesirable. For example, insufficient drainage may lead to lower dry-content in the dry section of a paper machine, whereby drying of the paper web will demand a high amount of energy. Additionally, additives may substantially increase the density of the paper.

There has been previous attempts to improve the strength of the paper in laboratory scale by the use of holocellulose, as described in YANG, X. et al. “Preserving Cellulose structure: Delignified Wood Fibers for Paper Structures of High Strength and Transparency” In Biomacromolecules, 2018, May, Vol. 19, No. 7, pp. 3020-3029, ISSN 1525-7797. However, there is still a need to improve the energy efficiency of the paper making processes for the production of paper with high strength, low dewatering resistance and low density. Additionally, there is a need for an affordable way to produce holocellulose fibres to transpose this concept to the industry.

### SUMMARY

It is an objective of the present invention to minimize problems identified in connection with the production of prior art holocellulose fibres. Additionally it is an objective to minimize problems identified in connection with the production of prior art high strength paper materials. Especially, it is an objective to provide an affordable way to produce holocellulose fibres useable in a process for the production of paper and provide a paper making process, which provides paper with improved strength while effective dewatering can be obtained during the manufacturing process.

It is also an object of the present invention to provide a paper, e.g. a paperboard product, having improved strength properties while the density of the paper is at least maintained at a prior level, i.e. not substantially increased.

It is also an object of the present invention to provide a papermaking process with improved dewatering. This is beneficial also for the pressing efficiency, and may result in a higher dry content after the press-section of a paper machine. Thereby, the need for drying energy in the drying process during the paper manufacture can be decreased.

Accordingly, the present disclosure relates to a method of producing holocellulose fibres useable in a process for the production of paper by treating wood-based raw material with an organic peroxide. The organic peroxide may be peracetic acid. The method comprises:
i. charging the organic peroxide continuously to the wood-based raw material during the treatment; and/or
ii. charging the organic peroxide to the wood-based raw material in at least two separate steps with an intermediate alkaline treatment step.

It has been surprisingly noted that by charging the organic peroxide continuously during the treatment instead of charging all organic acid in a batch in the beginning of a reaction, or by charging the organic peroxide in at least two steps with an intermediate alkaline step, the amount of the organic peroxide added during the production of the holocellulose fibres can be reduced. Especially in the method involving continuous charging of organic peroxide, it can be assured that the organic acid reacts mainly with the wood and not with itself. Thus, the total amount of the organic peroxide used for the production of holocellulose fibres can be reduced. Thereby, an affordable way to produce holocellulose fibres is obtained.

The method may comprise a step of charging the organic peroxide continuously to the wood-based raw material, or to a medium comprising the wood-based raw material. By the continuous charging of the peracetic acid a way to obtain a given peracetic acid concentration in the reactor is obtained. The continuous addition can be made on demand to the reactor by adding a source of a concentrated organic peroxide, suitably peracetic acid.

Alternatively or additionally, the method may comprise two separate steps of organic peroxide treatment with an intermediate alkaline treatment step. In the first step, the amount of the organic peroxide is adapted such that the reaction to produce holocellulose is initiated, but the reaction is not completed. In the second step the amount of the organic acid is adapted such that a desired delignification or whiteness level is reached. The intermediate alkaline step improves the efficiency of the organic peroxide during delignification through the removal of some of the dissolved lignin, and through the solubility under alkaline conditions of partly oxidized lignin. The removal of those two lignin fractions leads to a decrease of the peracetic acid need to obtain a certain degree of lignin removal. The intermediate alkaline treatment step may be performed at a pH of 8 or more, suitably from pH 10-12, a temperature of 15-100° C. at atmospheric pressure, and for a duration of at least 1 hour. Washes may be added between these steps. In at least one of the at least two separate steps of organic peroxide treatment, the organic peroxide may be charged batchwise or continuously to the wood-based raw-material during the treatment. Thus, the charging of the organic peroxide may be chosen in a flexible way.

By the method, holocellulose fibres may be produced in an affordable way, since the usage of organic peroxide, e.g. peracetic acid (PAA), can be reduced compared to what has been disclosed in the prior art.

In either of the method i) or ii), the organic peroxide treatment may be performed at a temperature of 15-100° C., suitably from 40 to 90° C. At this temperature range, the amount of the organic peroxide needed for the production of holocellulose fibres can be kept low. However, the lower the temperature, the longer the reaction time may be. A reaction performed at a temperature of 55-75° C. may be preferable, since the amount of the organic peroxide needed for the reaction may be kept at a low level, while the reaction time is still relatively short. In either embodiment i) or ii) of the method, the organic peroxide treatment may be performed at a pH of 3.8 to 5 or 4.0 to 4.8.

Furthermore, the continuous charging may be performed at one or more charge rates during the whole treatment. Thus, the charge rate may be easily adapted to the prevailing process conditions.

The present disclosure also relates to a method of producing a paper strength agent useable in a process for the production of paper comprising producing holocellulose fibres according to the above-described method, optionally microfibrillating the holocellulose fibres to provide holocellulose nanofibrils (CNF), drying the holocellulose fibres or the holocellulose nanofibrils and reslushing the dried holocellulose fibres or the holocellulose nanofibrils. In this way, a paper strength agent for use as an additive and based on the wood-based raw material can be provided.

The present disclosure also relates to a process for the production of paper comprising the steps of:
a. preparing a papermaking stock comprising an aqueous pulp slurry comprising cellulosic fibres and having a fibre consistency of from 0.1 to 40% by weight, wherein the cellulosic fibres comprise or consist of wood-based holocellulose fibres, and wherein the amount of the wood-based holocellulose fibres is from 0.5 to 100% by weight, based on the dry weight of the cellulosic fibres,
b. providing the stock to a wire and form a web;
c. dewatering the web;
d. drying the web.

The paper properties obtained with holocellulose fibres display a large increase in strength properties, e.g. tensile, compression, out-of-plane, stiffness and with limited impact or no impact at all on drainage. Thus, by the use of wood-based holocellulose fibres in the papermaking stock, paper with improved strength can be obtained while in the papermaking process effective dewatering is still possible. Additionally, wood-based raw-material for the holocellulose fibres is environmentally friendly and not principally aimed for global food production.

The wood-based holocellulose fibres may be produced by treating a wood-based raw material with an organic peroxide. The organic peroxide may be peracetic acid (PAA). Peracetic acid has the advantage that it is selective, but does not oxidize too much of the carbohydrates.

Preferably, the holocellulose fibres may be produced by the method as described above. In this way, a more affordable way of providing holocellulose fibres is obtained.

The wood-based raw material used for the holocellulose fibres may comprise hardwood and/or softwood material. Hardwood and softwood material are readily available at the northern hemisphere and in case the production is also at the northern hemisphere, long transport for the raw material can be avoided. Also, as mentioned above, hardwood and softwood materials do not compete with global food production in the same way as other plant based raw-materials, such as corn-based materials, which is a huge advantage. The wood-based raw material may consist of hardwood and/or softwood material.

It has been surprisingly noted that when the holocellulose fibres are added after a refining step in the step a) of preparing the stock, further improved strength properties can be obtained. Without binding to any theory, this may be due to retaining of the fibre structure, degree of cellulose crystallinity, hemicellulose content and its structure, whereby strength properties are positively affected.

The step a) of preparing the papermaking stock may comprise a step of adding to the aqueous slurry an additive, and beating and/or refining the aqueous slurry. Thus, readily available production equipment may be used for the present process. The additive may comprise the holocellulose fibres, which can be added in an amount of 0.5 to 80% by weight or from 2 to 60% by weight or from 4 to 55% by weight, based on the total weight of the cellulosic fibres. In this way, the production process will be economic while the strength of the paper can be improved without impairing the dewatering characteristics. The additive may comprise a dry strength agent chosen from nanocellulosic materials, charged and non-charged starch, gum derivatives, synthetic copolymers with acrylamide and combinations thereof. Dry strength additives may further improve the strength of the paper. It has been noted that cationic starch provides a synergistic effect in paper strength together with the holocellulose fibres. Therefore, the additive preferably comprises cationic starch. The cationic starch may be added for example in an amount of less than 10% by weight, e.g. from 0.5 to 5% by weight, or from 0.8 to 3% by weight, based on the dry weight of the stock.

According to a variant, the additive may comprise a holocellulose CNF, i.e cellulose nanofibrils produced from holocellulose fibres. Thereby, further improved strength properties may be obtained while the dewatering is not impaired to the same extent as with current CNF alternatives. The holocellulose CNF may be added in an amount of 0.1 to 10% by weight, or from 0.5 to 5% by weight, based on the dry weight of the stock.

Additionally or alternatively, the additive may comprise a wet strength agent, which can be a resin chosen from urea-formaldehyde resins, melamine-formaldehyde resins, polyamide-amine-epichlorohydrine resins and combinations thereof. Wet strength agent can be used in order to further enhance the dry strength of fibres.

Alternatively or additionally the additive may comprise a retention aid chosen from charged or non-charged polyacrylamide (PAM), polyethyleneimine (PEI), colloidal silica (CS) bentonite, and combinations thereof. The retention aid improves the retention of fine particles in the web. The additive can be cationic polyacrylamide (CPAM), whereby the retention of negatively charged fines can be improved.

The cellulosic fibres may comprise fibres from a kraft pulp, soda pulp, sulfite pulp, mechanical pulp, thermomechanical pulp, semi-chemical or chemi-thermomechanical pulp, recycled pulp or mixtures thereof in an amount of from 0-99.5% by weight, based on the dry weight of the cellulosic fibres.

The present invention also relates to a paper obtained by the process as defined above. The paper has high strength with a relatively low density, which is a huge advantage for example in packaging technology. Also, since the paper has a low or no content of lignin, the paper does not suffer from yellowing to the same content as papers containing no holocellulose fibres. Therefore, the paper can be used as a packaging material and or as a corrugated fibreboard.

The present invention also relates to the use of wood-based holocellulose fibres produced by treating a wood-based raw material with an organic peroxide in a process comprising a delignification and a washing step in a papermaking process for improving strength of paper. Suitably, the holocellulose fibres are added after a refining step in a papermaking process.

Further features and advantages are described in the following detailed description with reference to the appended drawings.

### BRIEF DESCRIPTION OF THE DRAWINGS

FIG. 1 shows the change in the height of the water gauge as a function of time during the dewatering process.

FIG. 2 shows the curve of FIG. 1 divided into two linear parts close to inflection point.

FIG. 3 shows a graph of the fibre length distribution.

FIG. 4 shows results from the dewatering measurements with the DDA in the sheet former with closed water system.

FIG. 5 also shows results from the dewatering measurements with the DDA in the sheet former with closed water system.

FIG. 6 shows the tensile strength vs the amount of added PAA fibres, PAA CNF or CMF gen 1 for the sheet produced with recirculating white water.

FIG. 7 shows the tensile strength index vs density for the sheet produced with recirculating white water.

FIG. 8 shows tensile stiffness index vs. density for the sheet produced with recirculating white water.

FIG. 9 shows strain at break vs density for the sheet produced with closed white water and added PAA fibres, PAA CNF or CMF gen 1.

FIG. 10 shows the SCT index vs density for the sheet produced with recirculating white water.

FIG. 11 shows the tensile strength index vs drain time in the sheet former for the sheet produced with recirculating white water.

FIG. 12 shows the tensile strength vs the final sheet density for laboratory sheets with recycled fibres and added PAA fibre, PAA CNF, CMF gen1 or CS.

FIG. 13 shows the tensile strength vs the drain time in the sheet former for laboratory sheets with recycled fibres and added PAA fibre, PAA CNF, CMF gen1 or CS.

FIG. 14 shows the effect of the addition of holocellulose fibres on the tensile strength index.

FIG. 15 shows the effect of the addition of holocellulose fibres together with cationic starch to the improved tensile strength.

FIG. 16 shows SCT index for sheets produced with recirculating white water.

FIG. 17 shows SCT index for sheets formed with holocellulose fibres and cationic starch.

FIG. 18 shows that the holocellulose fibres develop strength at a lower rate of densification.

FIG. 19 shows that addition of holocellulose fibres give a better strength with less densification compared to refining.

FIG. 20 shows that addition of holocellulose fibres to recycled fibres (OCC) improves the tensile strength and the dewatering significantly.

FIG. 21 shows the effect of washing the RF fibres in the form of OCC.

FIG. 22 shows that there is little densification observed with addition of holocellulose fibres.

FIG. 23 shows the effect of drying holocellulose fibres.

FIGS. 24 and 25 show tensile strength of films produced from holocellulose-based CNF and CMF gen 1, respectively.

FIG. 26 shows peracetic acid concentration (a.u.) against time (min) in a medium containing water, peracetic acid, acetic acid, peroxide and caustic soda.

FIG. 27 illustrates the consumption of peracetic acid per gram of wood given in arbitrary units in the method comprising the two-step PAA-addition with an intermediate alkaline step.

FIG. 28 illustrates the consumption of peracetic acid per gram of wood given in arbitrary units in the method comprising continuous PAA addition.

FIG. 29 illustrates the chemical composition of the samples.

FIG. 30 illustrates a drain time in a sheet former as a function of increasing tensile strength index in (kNm/kg) and as a function of increasing amount of holocellulose fibres in the pulp.

### DETAILED DESCRIPTION

One of the greatest challenges in the production of paper-based products, e.g. printing paper, packaging materials, tissue etc., all of which will be referred to as ‘paper’, is to increase the strength of paper without affecting adversely the removal of water during the manufacture of the paper. During the papermaking process with a conventional pulp, such as kraft, sulphate, mechanical pulp, as a raw material, an increase of the strength of the paper may however contribute to a decrease of the dewatering during the papermaking process. For example, a common way to increase the strength is to refine the pulp. The refining step increases the strength but has also a negative impact on the pulp drainability. Thus, there is a long-time felt need for economical and energy-saving papermaking processes to produce stronger paper-based materials without negatively affecting the drainability.

The inventors of the present disclosure have found that by using holocellulose fibres in the paper production process, the strength of the paper can be improved, while the drainability is not substantially affected. However, the production costs of the holocellulose fibres are high, and therefore there is a desire for a more cost-effective way of producing holocellulose fibres.

The inventors of the present invention have found an economical method of producing holocellulose fibres. It has been surprisingly noted that by a production method involving
i) charging the organic peroxide continuously to the wood-based raw material during the treatment; and/or
ii) charging the organic peroxide to the wood-based raw material in at least two separate steps with an intermediate alkaline treatment step,
   the total amount of the organic peroxide, such as peracetic acid (PAA), used for the delignification or wood in the production of holocellulose fibres can be substantially decreased compared to prior art methods in which organic peroxide is initially charged into a reactor at a large concentration. For example, it has been found that the organic peroxide may be used in a total amount of 2.0 g organic peroxide/g wood fibres or less, or 1.5 g organic peroxide/g wood fibres or less, especially when the wood-based raw material is in the form of larger wood chips. The amount may be less than 1.3 g organic peroxide/g wood fibres or less than 1.0 g organic peroxide/g wood fibres, when small wood chips, small veneer or matches are used as the wood-based raw material. By producing holocellulose fibres is in this context meant extraction of fibrous cellulosic material from wood-based raw material (wood), i.e. liberating cellulose fibres from other chemicals and impurities in the wood.

The method may thus comprise charging the organic peroxide continuously to the wood-based raw material during the treatment and/or charging the organic peroxide in at least two separate steps of organic peroxide treatment with an intermediate alkaline treatment step. The intermediate alkaline treatment step may performed at a pH of 8 or more, for example from pH 10-12. The temperature may be 15-100° C. at atmospheric pressure for a duration of at least 1 hour, such as 1 to 3 hours.

The organic peroxide may be peracetic acid (PAA). This chemical leads to a selective removal of the lignin. However, the known peracetic process used to produce holocellulose fibres has a prohibitive cost due to the production cost of the organic peroxide, e.g. peracetic acid. In the laboratory scale, the quantity of peracetic acid used can be in the magnitude of 2.5 g or more of peracetic acid, expressed as pure (pure) acetic acid, per gram of wood, which is considered too high for an industrial production. A more affordable way to produce those fibres is therefore desirable to transpose this concept to the industry. By the solution of the present invention, the quantity of peracetic acid needed for the industrial production of holocellulose can be reduced, while the final paper product maintains similar strength properties and dewatering properties during the papermaking as obtained with peracetic acid treatment at higher quantities. According to the present disclosure, the organic peroxide is not overdosed in the treatment process, whereby an affordable method to produce holocellulose fibres is provided. The method is also applicable in full-scale industrial plants.

Hereinbelow, the method is described more in detail with reference to peracetic acid. However, other organic peroxides may be conceivable.

The treatment or reaction thus may involve the use of peracetic acid and the wood-based raw material, with water. Water may be used as carrier or solvent. The reaction can be carried out in a reactor or vessel. If the vessel is pressurized, the reaction temperature may be higher. The reaction may last a few hours, during which the peracetic acid is consumed by the wood-based raw material. This means thus that the peracetic acid concentration decreases during the reaction in the vessel, unless it is compensated by continuous injection as suggested in embodiments of the present disclosure. The reaction may be carried out in a batch reactor or a continuous reactor.

In the previous trials of producing holocellulose fibres, a high concentration of peracetic acid has been initially added in a reactor, which in turn has led to high costs. Without binding to any theory, it is believed that this is partly due to the peracetic acid disappearing spontaneously at high concentrations by spontaneously reacting with itself, i.e. on other peracetic acid molecules. This behaviour may also occur at lower concentrations but to a substantially lesser extent. Thus, it has been noted that by keeping the peracetic acid at a low concentration, at least in the beginning of the reaction, most of the peracetic acid reacts with the wood instead of reacting with itself, whereby the total amount of the used peracetic acid is decreased and a more effective use of the peracetic acid is obtained.

However, by having a low concentration of peracetic acid in the beginning of the reaction, there is also a low quantity of the peracetic acid in the reactor. This low quantity may not be sufficient to treat all the wood. This is why more peracetic acid may be added to the reaction. In the previous attempts, a high concentration of peracetic acid is initially added to the reactor, and it is then waited until it is consumed. Subsequently, the reactor is flushed and new peracetic acid is added. Instead of waiting for all the peracetic acid to be consumed before adding new peracetic acid, according to a variant of the present invention, the peracetic acid can be continuously added by injection to the reactor. By continuously charging the organic peroxide is meant the action of using a source of concentrated organic peroxide to constantly adjust the peracetic acid concentration inside the reactor to a pre-set concentration. The main reason for that injection is to keep the concentration high enough for the reaction to happen at a sufficient speed, but low enough so that the main reactions in the reactor are the ones involving peracetic acid on wood, as opposed to the reactions involving peracetic acid on itself. In a way, the injection compensates for the peracetic acid consumption in the reactor, or allows a better control of the peracetic acid profile by adjusting its value through time to pre-set values. This continuous charging might be performed by using any kinds of injectors associated with a pump or any kinds of flow-making devices. The concentrated source of peroxy compound is preferably concentrated/distilled peroxy compound, but can also be an equilibrium solution that contains an organic acid and hydrogen peroxide and a given quantity of the associated organic peroxide or peracid (when applicable) or a diluted solution. The charging is performed as long as peracetic acid is needed to turn the wood into a material that is sufficiently delignified and/or white enough, for example for the production of white wood, or that it can be defibred, e.g. for the production of pulp-related products. Thus, the reaction will additionally be quicker, since there is no need to wait until the reaction is complete, which takes time, as the speed of the reaction decreases when the concentration decreases. By the continuous injection a given set concentration can be maintained during a desired reaction time. Thereby a low total charge is obtained. The injection may be performed with a side pump that is arranged to inject peracetic acid at a desired charge rate into the reactor during the reaction. By low charge is meant that the total consumption of the PAA is kept below 2 g PAA/g wood. At low charge the concentration may be for example at around 3% or peracetic acid in the reactor.

The peracetic acid injection or charge rate may be constant during the reaction time. Alternatively, the charge rate may be modified during the reaction. Thus, the continuous charging may be performed at one or more charge-rates during the whole treatment. The charge rates may be pre-determined or adjusted during the reaction. For example, the injection speed or rate could be modified in case of high deviation of the given peracetic acid set concentration in the reactor. That is, if the concentration is higher than the given set concentration in the reactor, then the injection speed is lowered for example by slowing down the speed of the injector. Injection speed depends on the amount of water in the reactor, meaning that if there is more water in the reactor than a desired amount of water, then more peracetic acid is injected to the reactor to reach a given set concentration in the reactor. In a similar way, the injection speed depends on the peracetic acid concentration in the mother peracetic acid solution, which is usually a distilled peracetic acid solution, with a concentration of 39% to 40% of peracetic acid. Another supply alternative could be a solution of equilibrium peracetic acid. The speed of the injection may be configured to be variable and automated, depending on the concentration of the peracetic acid in the reactor. In this way it is possible to have a better control of the peracetic acid concentration in the reactor, which in turn will give a better control of the reaction and of its speed in the reactor. The set concentration in the reactor, i.e. a target concentration in the reactor, may be for example from 2.5 to 3.5% of peracetic acid in solution, such as 3% of peracetic acid in solution. The concentration may also be set to vary during the reaction, for example 2.5% for the 2 first hours, and 3.5% during the 2 next ones, and finish at 3.0% for the last 2 hours. The pH of the reaction may be monitored and may be kept at a value of about pH 4. If the pH is decreased during the reaction, for example caustic soda may be batchwise of continuously injected into the reactor to keep the pH at around 4.

Thus, by the continuous injection of organic peroxide such as peracetic acid (PAA), it is possible to maintain a low total charge of PAA in the reactor. The reactor may contain the wood-based raw material, some water and a constant or controlled amount of peracetic acid. The reactor may additionally contain degradation products of the reaction, e.g. dissolved lignin and carbohydrates coming from the wood, their by products, the by-product of peracetic acid (acetic acid) and other chemicals, which may include hydrogen peroxide, dissolved oxygen, etc. Therefore, it is possible to reduce the quantity of peracetic acid needed for the production of holocellulose. In this way, it is possible to decrease the usage of peracetic acid to a low level, for example from about 0.3 to 0.7 g pure PAA/g wood. This amount corresponds to a minimum amount of fully oxidizing and thus removing lignin. However, holocellulose fibres may also be produced even if the lignin is not fully oxidized, but instead oxidized to a level so that it can be removed. The level of oxidization may be determined based on experiments, if desired. The continuous introduction of peracetic acid is a way to ensure the production of a product, while limiting its cost. Additionally, a better overall safety of the process can be ensured, since the risks of runaways are limited at those lower working concentrations. On the other hand, the method involving the use of at least two PAA treatment steps with an intermediate alkaline step allows for partial removal of some lignin. Since this lignin can be removed, there is no need to oxidize it, whereby it is possible to reach a further decreased usage of PAA, even less than 0.3 g pure PAA/g wood.

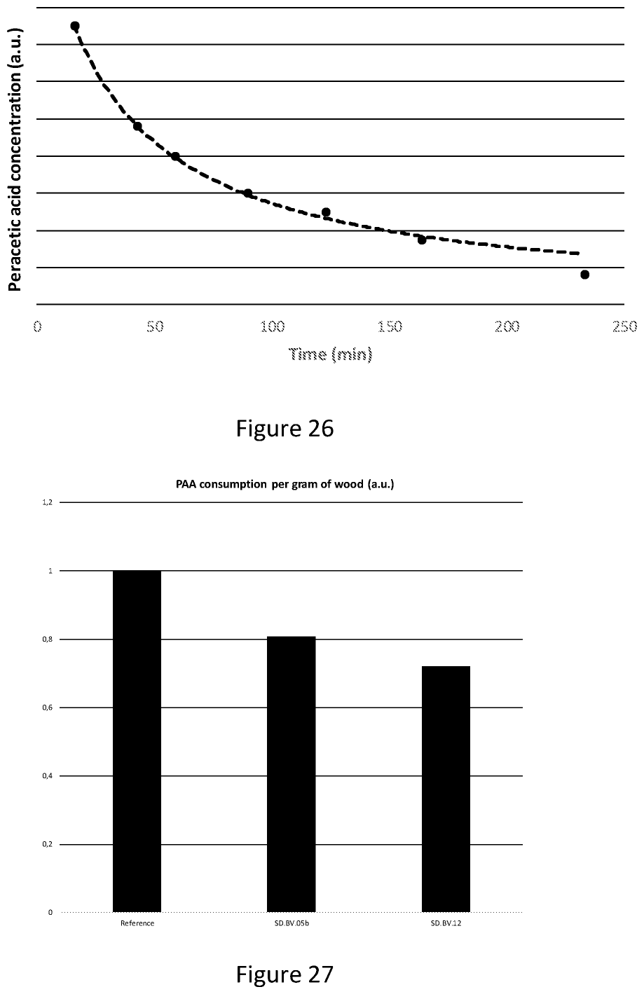

An analysis of the reactions involving peracetic acid under conditions in which a large amount of peracetic acid is initially added to a reactor show that a high initial charge of peracetic acid leads to a high consumption of peracetic acid for unnecessary purpose, i.e. those other than delignification. FIG. 26 illustrates the phenomenon and shows the consumption of peracetic acid by the reaction of peracetic acid in a reactor containing no organic material, apart from peracetic acid and acetic acid. FIG. 26 shows a peracetic concentration (a.u.) against time (min) in a medium containing water, peracetic acid, acetic acid, peroxide and caustic soda. In the FIG. 26, the results are shown with black dots and a corresponding model of the reaction involving peracetic acid under the conditions of the process in a reactor originally containing pH-adjusted water and peracetic acid is shown with a dotted line.

The present invention limits the magnitude of the unnecessary reactions of PAA with itself due to the low amount of PAA used. As described above, this can be achieved for example by continuously charging the peracetic acid in the reactor, and keeping the concentration continuously at a low concentration level. By doing so, the peracetic acid is more prone to react with the lignin of the material rather than mainly on itself. The consumption of peracetic acid to obtain a given reaction advancement is thus lowered, which leads to a lower cost to obtain a given product. This invention allows for a significant cost reduction for holocellulose production while maintaining the desirable fibre and therefore paper properties described here above.

According to another variant of the method of producing holocellulose fibres, i.e. pulping, according to the present disclosure, alkaline treatment can be used in between two peracetic acid stages. This means that the peracetic acid is used during pulping with an alkaline treatment between the two peracetic acid stages, whereby white holocellulose fibres are produced without a prior independent pulping step. Thus, the present alkaline treatment between peracetic treatment steps is different from alkaline treatments used in bleaching, in which the alkaline stages or extraction stages are carried out to remove oxidized lignin from fibres that have been produced in an independent pulping step. The present method provides therefore a cost effective process with few steps.

The first peracetic acid treatment step may have a relatively high initial peracetic acid concentration, and may be without continuous injection. The alkaline treatment is performed in between the first and a second peracetic acid treatment step. The second peracetic acid treatment step may be performed in a similar manner as the first peracetic acid step. Alternatively, the first and second peracetic acid treatment steps may be performed with low initial peracetic acid concentration and with continuous injection, as described above. The method may comprise one or more alkaline treatment steps and more than two peracetic acid treatment steps. For example, the method may comprise a first peracetic acid treatment step followed by a first alkaline treatment step, which is followed by second peracetic acid treatment step, followed by a second alkaline treatment step, further followed by an alkaline treatment step.

Before the alkaline treatment step, the reactor may be drained at the end of the peracetic acid treatment step. The reacted wood may be washed. A pH-adjusted water, which may be adjusted with for example caustic soda, may be added to the reactor. Alternatively, water could be added to the reactor and then the pH could be adjusted until an initial set pH is reached. The initial set pH may be more than pH 9, for example from pH 10 to 12. The pH usually decreases during the alkaline treatment. Suitably, an end pH could be chosen to be for example pH 10 or more, but is not limited thereto. Generally, to obtain the advantageous effects mentioned above, the end pH may be more than 7. The alkaline treatment step can have a duration of one hour or more. The temperature during the alkaline treatment steps can be 15-100° C. at atmospheric pressure, and could be for example 40-80° C. at atmospheric pressure. If the alkaline treatment is performed in a pressurized vessel, the temperature may be higher. Additionally, the pH may be higher than 12 in certain conditions. Also, the duration of the treatment may be adjusted to the prevailing conditions and may be for example 5 hours, or even longer. Alternatively, if the duration of the treatment may also be shorter, such as 10-30 minutes.

The organic peroxide steps mentioned in this disclosure are either two peracetic acid steps carried out for example by charging the organic peroxide at high concentration in the beginning of the treatment and by leaving it to react until the organic peroxide has reacted, then flushing the reacted wood, and then by adding the organic peroxide again. The procedure can be performed as many times as necessary.

The temperature during the reaction with the organic peroxide in the embodiments of the method for producing holocellulose fibres of the present disclosure may be 15-100° C., suitably from 40 to 90° C. or 55-75° C., for example about 70° C. The pH may be acidic, for example from 2.5 to 5, such as 4.0 to 4.8, and the pH can be adjusted by the addition of caustic soda. The temperature can be controlled with the circulation of a heated fluid around the reaction chamber with a pre-set temperature profile, which may vary for example by increasing gradually from 40 to 70 degrees Celsius. Alternatively, the organic peroxide steps may be performed with the continuous charging concept described above. For example, continuous charging may be performed such that the concentration of peracetic acid is kept at a value of 3%, with continuous pH adjustment and at a temperature of 60° C. or 70° C. adjusted with a heated liquid. In this way, the consumption of the peracetic acid may be reduced while the reaction time is kept relatively short.

Without binding to any theory, it is believed that the organic peroxide reacts with lignin in the wood-based raw material, whereby part of the lignin may be solubilized. However, part of the lignin which is oxidized by the organic peroxide, may stay linked to the fibres and may continue to use the organic peroxide. This oxidized lignin can be solubilized in alkaline conditions. Thus, the two step treatment with organic peroxide, which can be peracetic acid, with an intermediate alkaline step pertains to improving the efficiency of peracetic acid during delignification through the removal of some of the dissolved lignin, and through the solubility under alkaline conditions of partly oxidized lignin.

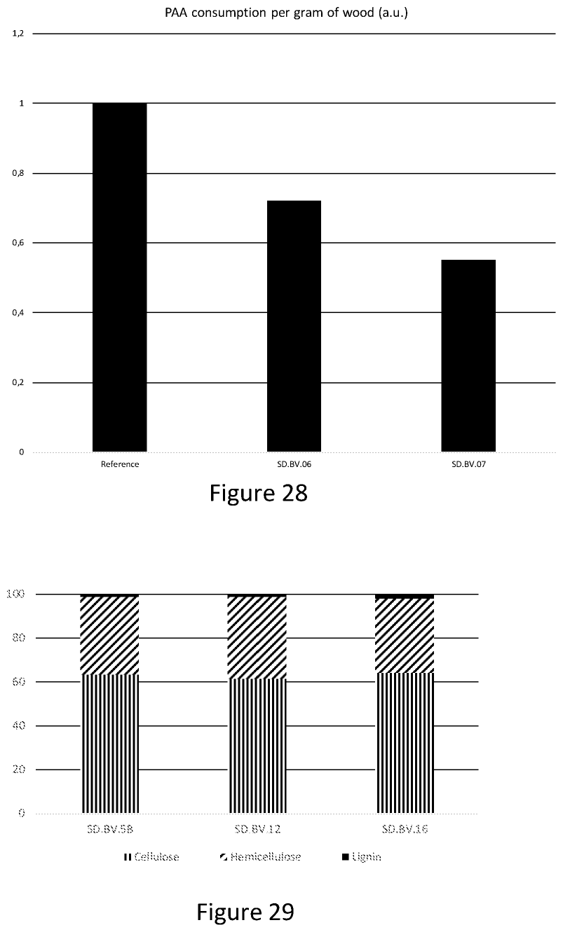

The removal of those two lignin fractions leads to a decrease of the peracetic acid need to obtain a certain degree of lignin removal, see the experimental part and especially FIGS. 27 and 28. The removal is an alkaline removal. For example, the removal can be via an alkaline treatment at a temperature of 25° C. to 70° C., with an initial pH of 12, which may evolve freely during for example one hour, or an alkaline extraction at a temperature of 25° C., pH kept at 12 with addition of caustic soda during for example one hour, and carried out here after a first wash with water.

The amount of peracetic acid needed to reach a certain delignification level is reduced, as can be seen in FIG. 26, leading in turn to a reduced holocellulose production cost in respect of the organic peroxide cost. The pulps obtained after those treatments are of similar properties and performance, and of similar composition, based on carbohydrate analysis, as the ones observed for the pulps treated under conditions involving the use of peracetic acid (PAA) in an amount of 2.5 g PAA/g fibres, see the experimental part and FIG. 29.

According to a further variant, it is possible to combine the method with continuous charging of organic peroxide and to split the peracetic acid reaction in two reactions separated by the alkaline step, which can be an extraction stage, i.e. an intermediate alkaline treatment at e.g. 70° C., for example pH 12-10, and for 1-3 hours. The peracetic acid consumption can reach then the value of 1.1 g/g. Those two ideas together led to a consumption of 0.7 g per g of wood.

According to a further aspect of the present disclosure, a method of producing a paper strength agent is provided. The method comprises the above-described steps for producing holocellulose fibres either by continuous injection of peracetic acid and/or by including an alkaline treatment step in between peracetic acid treatment steps. The produced holocellulose fibres may be optionally microfibrillated, as will be described more in detail below, to provide holocellulose nanofibrils (CNF). The produced holocellulose fibres or holocellulose nanofibrils is subsequently dried. In the final step the dried holocellulose fibres or the holocellulose nanofibrils are reslushed. The paper strength agent produced by such method provides a surprisingly strong paper, while the dewatering properties are not affected negatively.

In addition to the above-described methods, the inventors of the present invention have found an economical and efficient papermaking process that provides for improved paper strength while dewatering during the papermaking process is not substantially negatively affected. In the process a papermaking stock comprising an aqueous pulp slurry comprising cellulosic fibres and having a fibre consistency from 0.1 to 40% by weight, based on the weight of the stock, is prepared. By fibre consistency is meant the dry content of cellulosic fibres in the aqueous pulp slurry.

According to the invention the cellulosic fibres comprise or consist of wood-based holocellulose fibres. The wood-based holocellulose fibres are produced by treating a wood-based raw material with an organic peroxide, preferably peracetic acid (PAA). The wood-based holocellulose fibres provide strong paper while the dewatering during the papermaking process is not negatively affected.

The amount of the wood-based holocellulose fibres can be from 0.5 to 100% by weight, based on the dry weight of the cellulosic fibres. Thus, the wood-based holocellulose fibres can be used as a constituent, i.e. an additive in the pulp slurry comprising the cellulosic fibres or the wood-based holocellulose fibres can constitute the cellulosic fibres of the aqueous pulp slurry. By using the holocellulose fibres as an additive in the pulp slurry, the strength of the paper is improved while the drainage is not negatively affected, whereby an energy efficient process can be obtained.

“Paper” used in this context relates to a material made from pulp, which comprises cellulosic fibres. Paper is manufactured from an aqueous slurry comprising cellulosic fibres by pressing the moist fibres together and then dewatering and/or drying the fibres into thin, flexible material. Paper may be a single layer product or it may contain several layers. By paper is also meant equally e.g. printing paper, tissue paper, filter paper, paperboard and/or cardboard including corrugated fibreboard. Paperboard, cardboard or packaging board is a cardboard product made from a pulp, and can be made of several layers of paper. Corrugated fibreboard is included in the definition of paperboard/cardboard and refers to a material comprising fluted corrugated sheets and one or more flat liner layers.

By tissue paper is meant a very thin or light weight paper often produced with a paper machine comprising a steam heated drying cylinder (yankee cylinder) or by through-air-drying (TAD) of the tissue paper. Tissue paper has often a good absorbent capacity, for example from about 1 g liquid/1 g fibre, but may be more or less depending on the quality of the tissue paper.

Generally, cellulosic fibres can be fibres originating from unbleached or bleached pulp comprising a pulp selected from a kraft, soda, sulfite, mechanical, a thermomechanical pulp (TMP), a semi-chemical pulp (e.g., neutral sulfite semi-chemical pulp; NSSC), a recycled pulp or a chemi-thermomechanical pulp (CTMP), or mixtures thereof. The cellulosic fibres also inlcude the holocellulose fibres. The recycled pulp may be for example old corrugated cardboard/container (OCC). The raw material for the pulps can be based on softwood, hardwood or recycled fibres. The softwood tree species can be for example, but are not limited to: spruce, pine, fir, larch, cedar, and hemlock. Examples of hardwood species from which pulp useful as a starting material in the present invention can be derived include, but are not limited to: birch, oak, poplar, beech, eucalyptus, acacia, maple, alder, aspen, gum trees, and gmelina. Preferably, the raw material mainly comprises softwood. The raw material may comprise a mixture of different softwoods, e.g. pine and spruce. The raw material may also comprise a non-wood raw material, such as bamboo and bagasse. The raw material may also be a mixture of at least two of softwood, hardwood, and/or non-woods.

Cellulose nanofibril (CNF) in this application is sometimes referred to in the literature by the terms nanofibrillated cellulose (NFC), nanofibrillar cellulose (NFC), microfibrillated cellulose (MFC), microfibrillar cellulose (MFC), cellulose microfibril (CMF) and cellulose nanofibre (CNF). These terms are equally used and describe cellulose nanofibrils produced by mechanical treatment of plant/wood-based materials and may be combined with chemical or enzymatic pre-treatment steps. The mechanical treatment includes mechanical microfibrillation of fibres and can be performed for example high-pressure or ultrasonic homogenizers, grinders or microfluidizers, which expose the fibres to high shear forces. In this way the fibres are ripped into nanofibrils. Generally, cellulose nanofibrils are composed of at least one elementary fibril containing crystalline, paracrystalline and amorphous regions, with aspect ratio usually greater than 10, which may contain longitudinal splits, entanglement between particles, or network-like structures. The aspect ratio refers to the ratio of the longest to the shortest dimensions. The dimensions are typically 3-100 nm in cross-section and typically up to 100 μm in length. Cellulose nanofibrils produced from plant sources by mechanical processes usually contain hemicellulose, and in some cases lignin. Some cellulose nanofibrils may have functional groups on their surface as a result of the manufacturing process. The term cellulose nanoribbon has been used to describe cellulose nanofibrils from bacterial sources. The cellulose nanofibril may be defined in accordance with ISO/TS 20477:2017(en).

In the process of the present disclosure, the step of preparing the papermaking stock may comprise a step of adding to the aqueous slurry an additive, beating and/or refining the aqueous slurry. According to a variant, the additive may comprise a holocellulose CNF, i.e cellulose nanofibrils produced from holocellulose fibres. Thereby, further improved strength properties may be obtained while the dewatering is not impaired. The holocellulose CNF may be added in an amount of 0.1 to 10% by weight, or from 0.5 to 5% by weight, based on the dry weight of the stock.

Holocellulose is the total cellulose and hemicellulose fraction of wood and make up 65-75% by weight of the weight of fibres. Holocellulose is obtained by removing extractives and lignin from the original natural wood material, whereby holocellulose fibres are obtained. The holocellulose fibres are thus cellulosic fibres. The holocellulose in this application is wood-based and can be produced by delignifying wood with acid chlorite or peracetic acid (PAA). Holocellulose can be used to produce cellulose nanofibrils (CNF), and thus by holocellulose CNF is meant cellulose nanofibrils produced from holocellulose. Unlike other fibres with lower hemicellulose content, e.g. alkali treated fibres, drying the fibre does not seem to affect the subsequent nanofibrillation step. Moreover, films produced from holocellulose CNF have excellent mechanical properties. By using the wood-based holocellulose fibres, the strength properties of the produced paper can be improved while the dewatering properties are not impaired, which is a significant advantage in the papermaking process.

The process for the production of paper generally comprises the steps of stock preparation, feeding the stock comprising an aqueous slurry of cellulosic fibres to a forming section of the paper machine to form a web and dewatering the web. The stock preparation may include a step of addition of different additives to a pulp comprising cellulosic fibres. Also, the pulp is often mechanically treated by refining and/or beating. In the stock preparation step, different pulps may be mixed to form an aqueous pulp slurry suitable for use in the paper machine. The cellulosic fibres comprise or consist of holocellulose fibres produced by treating a wood-based raw material with an organic peroxide. The organic peroxide may be peracetic acid. Peracetic acid has the advantage that it is selective, but does not oxidate too much of the carbohydrates. The amount of the wood-based holocellulose fibres is from 0.5 to 100% by weight or from 0.5 to 80% by weight or from 2 to 60% by weight or from 4 to 55% by weight, based on the total weight of the cellulosic fibres. According to a variant the amount of the wood-based holocellulose fibres is from 25 to 50% by weight of the cellulosic fibres.

After the stock comprising the aqueous pulp slurry is prepared, it is provided to a wire of the forming section where a web is formed. Dewatering is a procedure by which water is removed from a wet pulp web. Dewatering can be performed mechanically during the web formation on a wire for example by means of pressure, vacuum or centrifugal forces. Dewatering can also partially be performed in a pressing section of a paper machine by means of mechanical forces, e.g. by means of pressing. After dewatering on a wire and/or in a pressing section, the web can be forwarded to a drying section, in which the remaining water/moisture in the web is evaporated by means of heat, which is also called thermal dewatering. The drying section may be designed in different ways and can comprise e.g. multi-cylinder dryer, yankee cylinder drying, through-air-drying or flash drying equipment.

By moisture content is meant the water content of the material expressed in weight %, and based on the total weight of the material.

In order to enhance the strength of paper, there are several different groups of suitable additives as dry strength aids including, but not limited to, nanocellulosic materials, such as microfibrillar cellulose, cellulose nanofibrils, cellulose filaments, nanocrystalline cellulose, fines or fines-enriched-pulps including holocellulose CNF and preferably wood-based holocellulose CNF, charged or non-charged starch such as cationic starch, gum derivatives, synthetic copolymers with acrylamide, such as acrylic acid, vinyl pyridine, 2-aminoethyl methacrylate, diallyl-dimethyl ammonium chloride, dimethyl-amino-propylacryl amide, diamine ethyl acrylate, styrene and glyoxalated polyacrylamides. The latter group is also suitably copolymerized with cationic monomers. By the use of cationic starch as an additive together with the holocellulose fibres, synergistic effects in strength improvement can be obtained at low starch addition levels. The cationic starch may be added in an amount of less than 10% by weight, e.g. from 0.5 to 5% by weight, or from 0.8 to 3% by weight, based on the dry weight of the stock. Especially advantageous effects can be obtained if the cellulosic fibres may comprise holocellulose fibres from 0.5 to 80% by weight or from 2 to 60% by weight or from 4 to 55% by weight or from 20-30% by weight.

Additives referred to as wet strength agents or resins such as urea-formaldehyde resins, melamine-formaldehyde resins or polyamide-amine-epichlorohydrine resins are also useful in order to enhance the dry strength of fibres. Such dry strength aids or wet strength resins are suitably added to the pulp slurry during paper production, whereby the strength of the final paper or paperboard product can be improved. Retention agents can also be used, alone or in combination. Retention agents may be chosen from polyacrylamide (PAM), which may be cationic (CPAM), polyethyleneimine (PEI), colloidal silica (CS), which may be negatively charged, bentonite and combinations thereof. The retention aid may be added in a total amount of about 1 to 50000 g/ton, for example in an amount from 100-5000 g/ton, based on the weight of the stock.

Further advantages and features of the present invention are described in the following examples, which should not be regarded as limiting the scope of the invention.

### Examples

The effects and further advantages obtained by the present invention are illustrated in the experimental part of the description herein below. The effect of adding holocellulose fibres or CNF, that has been treated with peracetic acid (PAA), as a dry strength agent to laboratory sheets was investigated. The holocellulose fibres treated with PAA have been referred to as PAA fibres and the cellulose nanofibrils treated with PAA have been referred to as PAA CNF. The strength agents effect on the wire dewatering in the sheet former and final sheets tensile properties were studied.

Materials

TABLE 1
The materials and chemicals used in the study.

| Description | Product | Company |
|---|---|---|
| Unrefined softwood | Södra green | Södra |
| bleached kraft (SBK) | | |
| Recycled fibre (RF) | — | DS Smith |
| Peracetic acid (PAA) fibre | | RISE Innventia AB |
| (Birch) | | |
| PAA cellulose nanofibrils | | RISE Innventia AB |
| (CNF, Birch) | | |
| Cellulose microfibrils | Generation 1, pilot | RISE Innventia AB |
| (CMF) | | |
| Cationic starch (CS) | Amylofax pw | Ave be |
| Cationic polyacrylamide | Fennopol KF430T | Kemira |
| (CPAM) | | |
| Silica | Fennosil 900 | Kemira |
| Bentonite | Hydrocol OM | Axchem |

The unrefined softwood bleached kraft (SBK, Södra green) was reshlushed according to ISO 5263-1 as valid on the priority date of the present application. The SBK was refined to two levels with 200 and 400 kWh/ton using a Voith laboratory refiner (segment 3-1.0-60) and the Schopper-Riegler values were 24 and 63 respectively.

The recycled pulp was prepared by reshlushing testliner (DS Smith) according to ISO 5263-1 and contained 14 wt % filler. Two separate set of experiments were performed, one set using the reslushed pulp in its original form, and second where the pulp was washed in order to remove the filler and anionic trash in the pulp. The reshlushed recycled fibres were washed by 1) adjusting the suspension to pH 2 with hydrochloric acid (HCl), after 30 min the suspension was filtrated (100 μm screen) 2) washing with 10 l. of acidic water (HCl, pH 2) 3) washing with deionized water until the conductivity in the filtrate was less than 5 μS/cm 4) adjusting the concentration sodium carbonate (Na₂CO₃) to 0.001 M 5) after 10 min the suspension was adjusted to pH 9 with sodium hydroxide (NaOH) 6) after 30 min, the pulp was washed with deionized water until the conductivity in the filtrate was less than 5 μS/cm. The filler content in the washed recycled pulp was 3.6 wt %.

The holocellulose fibres were produced with the peracetic acid (PAA) treatment with two pre-treatment steps, a delignification step and a washing step. The fibres are referred to herein as PAA fibres. In the first pre-treatment step, the wood chips (Birch, 35 g) were soaked in water and placed under vacuum until they no longer float. Thereafter, the cut fibres were treated with an aceton/water solution to remove extractives. In the second pretreatment step, the fibres were added to a diethylenetriaminepentaacetic acid (0.3 wt. %)/sodium sulfite (4 wt. %) solution (pH, 6, 85° C.) and allowed to react for 1 h in nitrogen atmosphere. The solution was cooled down and filtrated, and this step was repeated until the conductivity was less than 5 μS. In the delignification step, the wood chips were immersed in an 800 ml, 10% PAA solution that was adjusted to pH 4.8 with NaOH. The suspension was heated to 85° C. and allowed to react for 1 hour. To stop the reaction the suspension was cooled and filtrated. The delignification step with PAA was repeated three times before reshlusing the fibres with 5000 revolutions. In the washing step the pulp suspension was adjusted to pH 12 with NaOH, after two hours the pulp was washed with deionized water until the conductivity was less than 5 μS, Izothiazolin biocide (0.2 ml/l.) was added to the pulp suspension. The total amount of PAA used was 2.08-2.03 g PAA/g wood, i.e. more than 2 g PAA/g wood.

The holocellulose PAA CNF was produced by homogenizing the never dried holocellulose PAA fibres (3.3 wt %) with homogenizer (M-110 EH, Microfluidics) at 1700 bar and one passage through 200 μm and 100 μm chamber at 1700 bar. The PAA fibres were readily fibrillated and no pre-treatment of the fibres was required. The same homogenization procedure was used for producing PAA CNF from dried PAA fibres. The PAA fibres (30 g, dry basis) were dried in a ventilated oven for 4 h at 90° C. and reshlushed according to ISO 5263-1.

The CMF, referred to as RISE Innventia AB generation 1 pilot or CMF gen 1, was produced from never dried bleached sulphite softwood pulp that was pre-treated by refining it twice with an enzymatic treatment (FiberCare®, Novozymes, Denmark) step in between. The pre-treated pulp was homogenized with one passage through a pilot homogenizer (GEA, Ariete NS3034, Niro Soavi) at 1200 bar.

Methods

This study was divided into two parts with different furnishes. In the first part, laboratory sheets with SBK were produced, the unconditioned grammage was 100 gsm. The effects on the dewatering capability of the stock and the sheets physical properties with addition of PAA fibre, PAA CNF, CMF gen 1, CS or refining the pulp were investigated.

The laboratory sheets were produced with either an open or closed white water system. The retention of fines and added dry strength agent for the laboratory sheets with closed white water system were controlled by building up an equilibrium in the white water. For the trial points with SBK and an open white-water system the retention of fines and added dry strength agents was aided by the addition of 500 g/ton CPAM and 600 g/ton silica.

The effect of drying the pulp was investigated, laboratory sheets were produced from unrefined SBK or PAA fibres that were dried and reslushed. Laboratory sheets with SBK were produced from pulp that was dried and reslushed once (OD) or twice (TD). Laboratory sheets with PAA fibres were produced from pulp that was never dried (ND) or dried once (OD) and reslushed.

In the second part of the study laboratory sheets with recycled fibre (RF) also referred to as OCC (old corrugated container) furnishes were produced, the unconditioned grammage was 120 gsm. The effects on the wire dewatering and the sheets physical properties with addition of PAA fibre, PAA CNF, CMF gen 1 or CS were investigated. The laboratory sheets in the second part were produced with a closed white water system. Laboratory sheets were produced with either 1) washed RF with low filler content (3.6 wt. %) and no retention aid or 2) reshlushed RF that contained 14 wt. % filler, for these trial points 200 g/ton CPAM and 4000 g/ton bentonite was added.

PAA CNF was produced by homogenizing either never dried or dried and reshlushed PAA fibres. The homogenizing corresponds to the mechanical microfibrillation of the fibres. The reinforcing effect with addition of PAA CNF produced from never dried (ND) or once dried (OD) PAA fibres was compared for laboratory sheets with reslushed RF. Moreover, films were produced with 100% PAA CNF (ND), PAA CNF (OD) or CMF gen1 and their tensile properties were evaluated, the films grammage was 30 gsm. Table 2 below shows a summary of the trial points in the study. The sheets were produced with an open or closed white water system, as explained below. The properties that were evaluated, tensile properties (tensile), dewatering sheet former (DSF), dynamic drainage analyser (DDA) and short compression test (SCT). The effect of drying and reshlushing fibres was investigated for SBK, PAA fibre and PAA CNF, where ND is never dried, OD is never dried and TD is twice dried.

| Dry strength | Addition level/ | | | White | Retention | Method/ |
|---|---|---|---|---|---|---|
| agent | Variable | Pulp | Grammage | water | aid | Properties |
| Reference | | SBK | 100 | Closed | No | Laboratory sheet, DDA |
| PAA fibre | 2, 5, 25, 50, 100% | SBK | 100 | Closed | No | Laboratory sheet, DDA |
| PAA CNF | 2, 5, 10% | SBK | 100 | Closed | No | Laboratory sheet, DDA |
| CMF gen1 | 2, 5, 10% | SBK | 100 | Closed | No | Laboratory sheet, DDA |
| Refining | SR 24 & 63 | SBK | 100 | Closed | No | Laboratory sheet, DDA |
| CS | CS: 0-5% | SBK | 100 | Open | Yes | Laboratory sheet |
| PAA fibre/CS | 25%, CS: 0-5% | SBK | 100 | Open | Yes | Laboratory sheet |
| PAA CNF/CS | | SBK | 100 | Open | Yes | Laboratory sheet |
| CMF gen1/CS | 5%, CS 0-5% | SBK | 100 | Open | Yes | Laboratory sheet |
| PAA CNF | 2, 5, 10% | SBK | 100 | Open | Yes | Laboratory sheet, DDA |
| CMF gen1 | 2, 5, 10% | SBK | 100 | Open | Yes | Laboratory sheet, DDA |
| — | OD/TD | SBK | 100 | Open | | Laboratory sheet |
| — | ND/OD | PAA fibre | 100 | Open | | Laboratory sheet |
| Reference | | RF | 120 | Closed | Yes | Laboratory sheet, DDA |
| PAA fibre | 10, 25% | RF | 120 | Closed | Yes | Laboratory sheet, DDA |
| PAA CNF, ND | 2, 5% | RF | 120 | Closed | Yes | Laboratory sheet, DDA |
| PAA CNF, OD | 2, 5% | RF | 120 | Closed | Yes | Laboratory sheet, DDA |
| CS | 0.8 , 1.5% | RF | 120 | Closed | Yes | Laboratory sheet, DDA |
| CMF gen1 | 2, 5% | RF | 120 | Closed | Yes | Laboratory sheet, DDA |
| PAA CNF/CS | | RF | 120 | Closed | Yes | Laboratory sheet, DDA |
| Ref | | Washed RF | 120 | Closed | | Laboratory sheet, DDA |
| PAA CNF | 5% | Washed RF | 120 | Closed | | Laboratory sheet, DDA |
| PAA CNF/CS | 5/1.5% | Washed RF | 120 | Closed | | Laboratory sheet, DDA |
| PAA CNF, ND | | — | 30 | — | | Film |
| PAA CNF, OD | | — | 30 | — | | Film |
| CMF gen1 | | — | 30 | — | | Film |

The dosage strategy:
1. Add dry strength agent, mix 30 s
2. Add CS, mix 120 s
3. Add CPAM, mix 30 s
4. Add microparticle, mix 30 s

The added dry strength agent was either PAA fibre, PAA CNF or CMF gen1. The added microparticle was silica for the trial points with SBK and bentonite for the trial points with recycled fibre. The dosing step was only applied if the trial points containing dry strength agent, CS or retention aid.

Evaluation of Pulp Properties

The following properties were evaluated for the pulps:
Schopper-Riegler (SR): ISO 5267-1
Water retention value (WRV): SCAN-C62:00
BDDJ fines content <76 μm: SCAN-CM 66:05

The fibre length distribution was measured using L&W FiberTester. The Z-potential of the pulp was measured with the SZP-10 System Zeta Potential meter (Mütek).

Laboratory Sheets

Laboratory sheets were produced with two methods, conventional sheet former with either open or closed water system. The laboratory sheets with open water system were produced according to ISO 5269-1. The laboratory sheets with closed water system, i.e. recirculating white water was produced according to ISO 5269-3. An advantage with using a closed system is that the retention of fines and filler can be controlled by creating an equilibrium in the white water system. Ten sheets were prepared to produce a retention equilibrium, these sheets are discarded and are not used in the paper testing.

Dewatering in Sheet Former

The dewatering in the sheet former was analysed by tracking water gauge height with an Ultrasonic sensor, UC500-L2-U-V15 from Pepperl-Fuchs. In the method the dewatering speed and dewatering time of a sheet making process in a Finnish former are evaluated. The height of a water pillar was measured in real time until all the water is drained from the Finnish former and just a paper sheet is left on the wire. The term “dewatering speed” is referred to as the speed that the fiber suspension has when draining from the sheet former, and is measured in [m/s] and takes into account the whole time that the draining process last. This time is referred to “dewatering time” and measured in seconds and the method is further described in the Master's Thesis: “The influence of dewatering speed on formation and strength properties of low grammage webs”, by Pulgar H, Tysen A, Vomhoff H, Brännvall E.

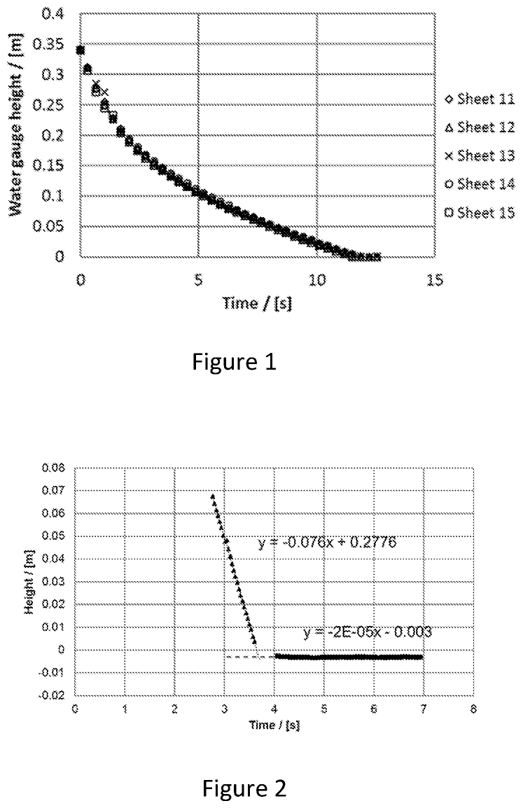

FIG. 1 in the appended drawings shows the change in the height of the water gauge as a function of time during the dewatering process. The example shows the dewatering for five sheets from a trial point with closed white water system. Sheets no. 1-10 were only produced to build up an equilibrium in the white-water system and were not used for analysing the dewatering or evaluating the final sheet properties.

There was no distinct point where the web could be considered to be completely dewatered. Therefore, the curve was divided into two linear parts close to inflection point and the drain time was extracted by taking the intercept between the linear trendlines, see Fel! Hittar inte referenskälla. The drain time for a trial point was determined by taking the average of five measurements.

Dewatering with Dynamic Drainage Analyser DDA

The dewatering was analysed using the Dynamic drainage analyser (DDA) 5 (Pulpeye). The same mixing speed and contact time between the chemical additions was used when producing the laboratory sheets and in the DDA measurement. The pulp consistency was 5 g/l and the start vacuum was 250 mbar.

Physical Properties of the Paper Sheets

The following properties were evaluated for the laboratory sheets:
Grammage: ISO 536
Thickness: ISO 534:2011
Density: grammage ISO 536/thickness ISO 534:2011
Tensile properties: ISO 1924-3
Short compression test (SCT): ISO 9895
Ash content (525° C.): ISO 1762

Test Results

The pulps drainability was analyzed by measuring the Schopper-Riegler (SR) and the degree of fibre swelling was analyzed by measuring the pulps water retention value (WRV). The degree of fibre swelling correlates well with the strength of the final paper. Moreover, the degree of fibre swelling will affect press dewatering and it is known in the art that a higher WRV correlates to a lower dry content after wet pressing. At the same level of drainability the PAA fibres had high degree of fibre swelling when compared to unrefined bleached softwood kraft (SBK). The fibre swelling for the SBK pulp could be improved by refining but deteriorated the drainability of the pulp, see Table 3. The SBK refined to SR 63 only had slightly higher WRV compared to the pulp refined to SR 24. Therefore, when the final sheet properties or dewatering properties were analyzed the comparison with beating was made with the trial points containing SBK refined to 24.

It should be noted, the standard for WRV (SCAN-C 62:00) is limited to samples with cellulose fibres. Hence, the WRV for the recycled pulps, the CMF or CNF materials are not measured according to the standard, the WRV for these materials still gives an indication of how their properties differ.

The pulps were characterized using the L&W (Lorentzer & Wettre) fibre tester, which measures fibre length, width, fines (P&S), shape factor, macrofibrils and coarseness by image analysis. FIG. 2 shows a graph of the fibre length distribution, length weighted, measured with L&W fibretester. The PAA fibres contained 5.5-6.8 wt. % fines, which is defined as the fraction particles with a length of 0-0.1 mm. The pulps were also characterized by the shape factor, which is a measurement of how straight the fibres are, a higher shape factor corresponds to a straighter fibre. The PAA fibres had a 96.6% in shape factor which can be compared to softwood pulp which usually have a shape factor in the range 80-90% and 85-95% for mechanical pulps.

The PAA CNF had lower fines content compared to CMF gen1 but three times higher WRV.

Table 3 below shows the pulp properties were characterized by measuring Schopper-Riegler (SR), water retention value (WRV), shape factor Fibertester (FT), fines content (FT), fines content britt dynamic drainage jar (BDDJ) and filler content.

| | | | Shape | | Fines | Fines | |
|---|---|---|---|---|---|---|---|
| | | | factor, | Kinks, | content, | content, | Filler |
| | | | FT | FT | FT | BDDJ | content |
| Material | SR | WRV | % | Kinks/mm | % | wt. % | wt. % |
| Unrefined SBK | 11.93 | 0.89 | 83.10 | 0.61 | 6.90 | 5.17 | |
| Refined SBK | 23.80 | 1.61 | 86.10 | 0.33 | 5.20 | 8.87 | |
| Refined SBK | 63.00 | 2.00 | 86.10 | 0.35 | 7.90 | 14.42 | |
| Recycled fibre (RF) | 42 | 0.99 | 91.85 | 0.32 | 26.80 | | 14.00 |
| Washed RF | | 1.19 | 91.90 | 0.29 | 23.30 | | 3.60 |
| PAA fibre | 12.94 | 1.54 | 96.60 | 0.02 | 6.70 | 3.75 | |
| PAA CNF | | 9.42 | | | | 45.23 | |
| CMF gen1 | | 2.96 | | | | 69.36 | |

Kraft Pulp, Dewatering and Sheet Properties

Laboratory Sheets with SBK and No Retention Aid

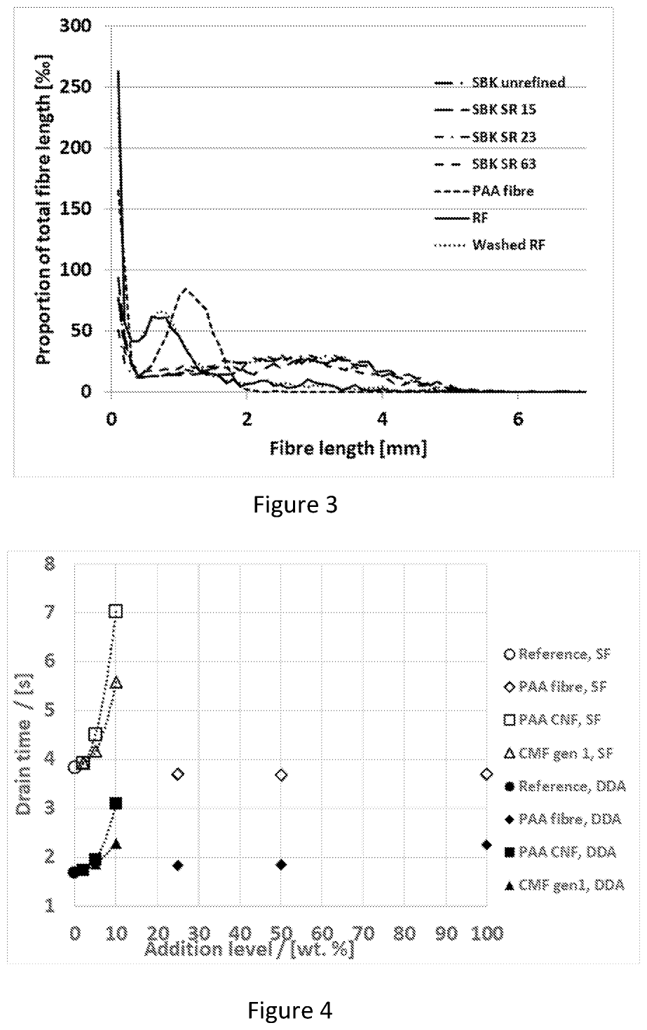

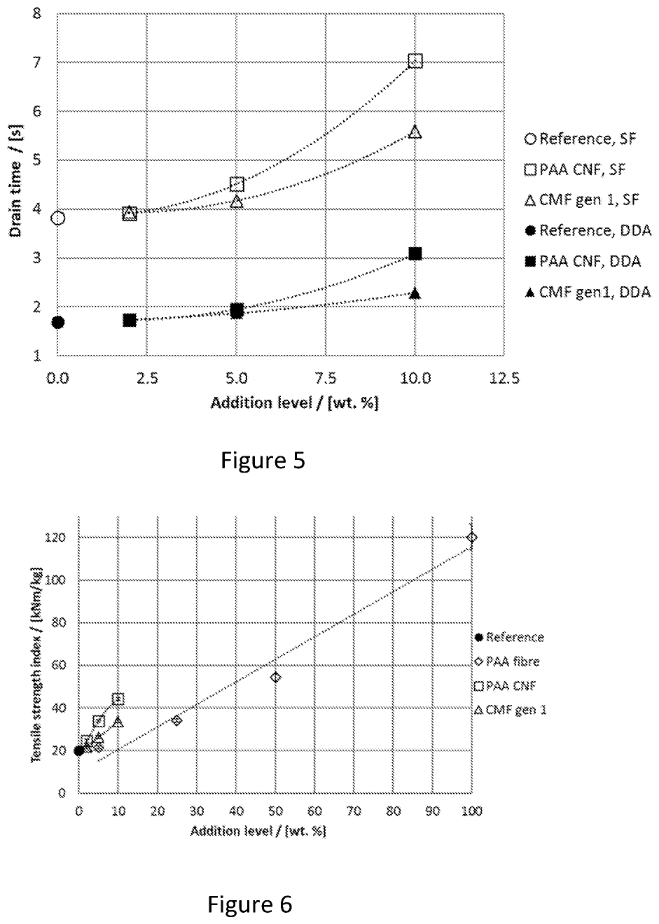

The dewatering was characterized by measuring the drain time in the sheet former and with the dynamic drainage analyzer (DDA), as described above. If the two methods that were used for measuring the dewatering are compared, it is evident that the drain time was higher in the sheet former. This can be explained by the fact that the sheet former had a larger volume of water that was drained (≈10 litres) compared to the DDA (0.5 l). It should be noted that there were also differences in the grammage and the applied vacuum in the two methods. However, the results from the dewatering measurements in the sheet former and with the DDA show similar trends, see FIG. 3 and FIG. 4.

The drain time rapidly increased with the amount of added micro or nanocellulose particles, CMF gen 1 or PAA CNF. The negative effects on dewatering with the addition PAA CNF and CMF gen1 could be explained by their small size enabling them to be redistributed by the water flow in the porous wet fibre web. There is a probability that the small particles will be mechanically entangled when passing through the channels in the wet web, thereby effectively blocking channels and inhibiting the water flow through it. This is referred to as the “choke point hypothesis” and an accumulation of small particles in the wet web will lead to increased dewatering resistance.

The addition of PAA fibres did not affect the wire dewatering in the sheet former when compared to the reference with unrefined SBK. This finding is supported by the result from the Schopper-Riegler drainability measurements, where the pulps had similar values.

FIG. 3 shows the effect on drain time with addition of PAA fibres, PAA CNF or CMF gen 1 in the dynamic drainage analyser (DDA) and in the sheet former (SF) for laboratory sheets with closed water system, i.e. recirculating white water. FIG. 4 shows the effect on drain time with addition of PAA CNF or CMF gen 1 in the dynamic drainage analyser (DDA) and in the sheet former (SF) for laboratory sheets with closed water system, i.e. recirculating white water.

Further, the tensile strength increased with increased addition of PAA fibres, PAA CNF and CMF gen 1 see FIG. 6. It can be seen that the strength development was more efficient with PAA CNF compared to the PAA fibres and CMF gen1, i.e. a higher tensile strength at a lower addition level. FIG. 6 shows the tensile strength vs the amount of added PAA fibres, PAA CNF or CMF gen 1 for the sheet produced with recirculating white water. The error bars are the standard deviation. The trial point with 100% PAA fibre was made from the second batch.

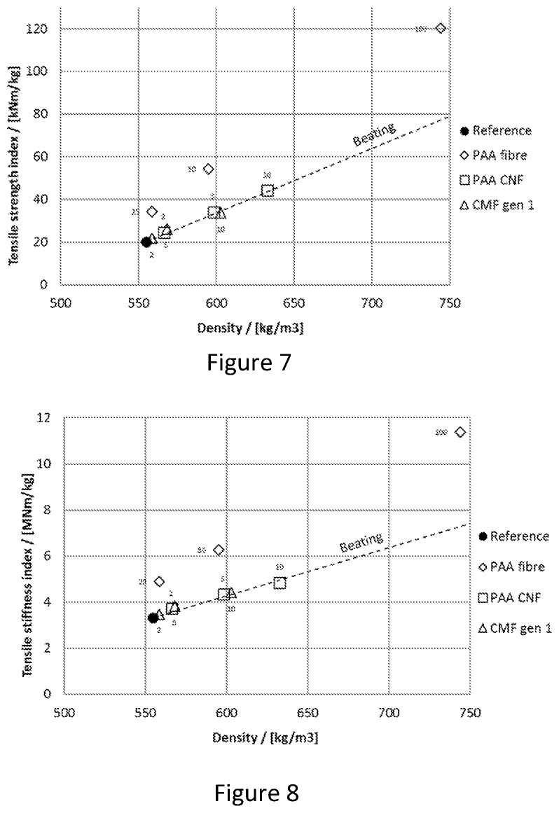

As expected, the increase in tensile strength with the addition of strength additives densified the sheet, see FIG. 18. The development in tensile strength and density for PAA CNF and CMF gen 1 followed that of beating. The sheets with PAA fibres deviated and had a different strength and density development, at the same strength level, the sheets with PAA fibres had a higher bulk compared to PAA CNF, CMF gen 1 and beating. The tensile strength for the trial points with PAA fibres increased linearly with addition levels, however, the density did not. Lower addition levels of PAA fibre (0-50 wt. %) had a relatively small effect on the density when compared to the sheet with 100% PAA fibre. The addition of 50 wt % PAA fibre resulted in an absolute increase in density and tensile strength of 41 kg/m³ and 34 kNm/kg respectively. On the other hand, the sheet with 100% PAA fibre had 220 kg/m³ increase in density and 100 kNm/kg increase in tensile strength when compared to the reference with 100% unrefined SBK, see FIG. 7. This result indicates that 1) the PAA fibres readily collapses and 2) adding kraft fibres to the PAA pulp can provide structural rigidity to the wet web, preventing it from collapsing during the pressing. FIG. 7 shows the tensile strength index vs density for the sheet produced with recirculating white water. The data labels are the weight percent added dry strength agent, the labels are positioned below the marker for CMF gen1, above the marker for PAA CNF and left of the marker for PAA fibre.

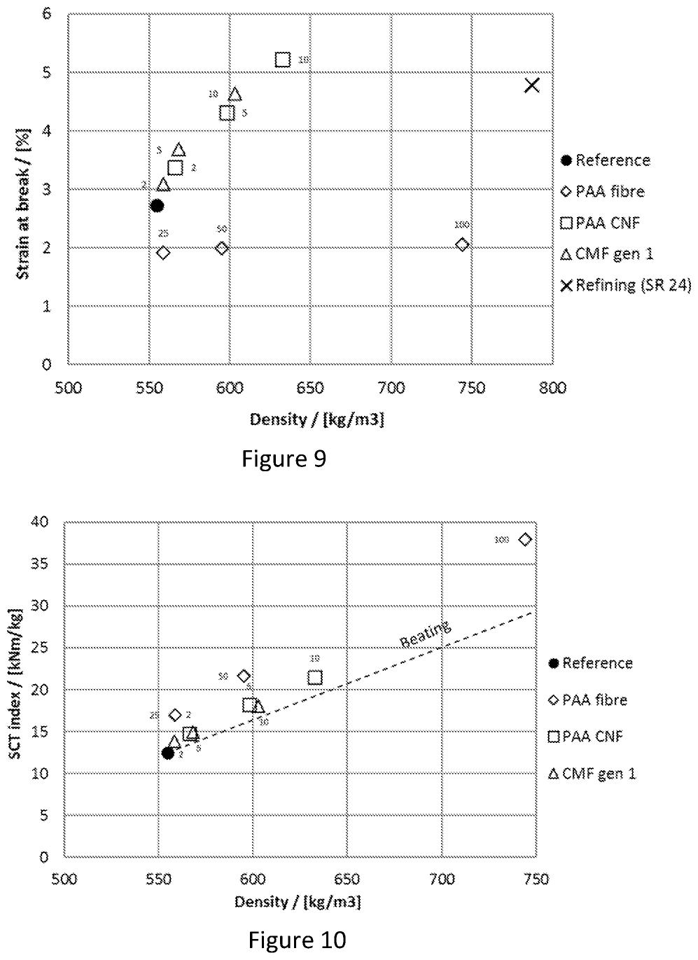

The tensile stiffness and tensile strength had similar development, the stiffness increased with the density for PAA CNF and CMF gen 1 and followed the same trend as beating. The sheets with PAA fibres had higher stiffness, at the same density level, compared to PAA CNF, CMF gen 1 and beating, see FIG. 8. The strain at break was improved by the addition of the PAA CNF and CMF gen1 but decreased slightly with the addition of PAA fibres, see FIG. 9.

The trial points with PAA fibre had the high stiffness and low strain at break, interestingly, on the other hand, the sheets with PAA CNF had high strain at break. The difference in how strain at break and stiffness develops with addition of PAA fibres or PAA CNF shows the importance of the addition level and the sizes of the PAA cellulose for the final sheet properties. FIG. 8 shows the tensile stiffness index vs density for the sheet produced with recirculating white water. The error bars is the standard deviation. The data labels are the weight percent added dry strength agent, the labels are positioned below the marker for CMF gen1, above the marker for PAA CNF and to the left of the marker for PAA fibre. FIG. 9 shows the strain at break vs the density for laboratory sheets with closed white water and added PAA fibres, PAA CNF or CMF gen 1. The data labels are the weight percent added dry strength agent, the labels are positioned left of the marker for CMF gen1, right of the marker for PAA CNF and above the marker for PAA fibre.

The sheets with PAA CNF CMF gen 1 and PAA fibres had at a given density level, higher SCT strength compared to refining, see FIG. 10. FIG. 10 shows the SCT index vs density for the sheet produced with recirculating white water. The error bars are the standard deviation. The data labels are the weight percent added dry strength agent, the labels are positioned below the marker for CMF gen1, above the marker for PAA CNF and to the left of the marker for PAA fibre.

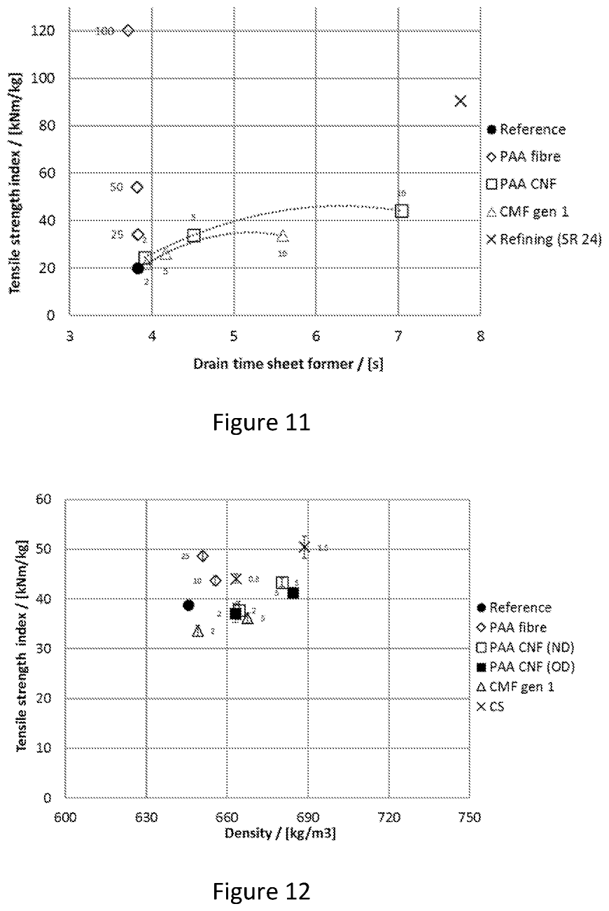

In FIG. 11, the tensile strength is plotted against the drain time for the laboratory sheets with recirculating white water. The strength of the sheets with PAA fibre increased with the addition level without impairing the wire dewatering. The sheets with PAA CNF had for a given strength level improved dewatering when compared to the sheets with CMF gen1. The effect on tensile strength and drain time with addition of 2 and 5 wt. % CMF gen1 or PAA CNF seems to be following a similar trend as refining. However, at higher addition levels (10 wt. %) of CMF gen1 or PAA CNF, the negative effects on the wire dewatering were more severe and the development in tensile strength and dewatering was inferior to that of refining. The impaired wire dewatering at higher addition level of CMF or CNF can be explained by the accumulation of small cellulose particles close to the wire that decreases the permeability of the web. FIG. 51 shows the tensile strength index vs drain time in the sheet former for the sheet produced with recirculating white water. The data labels are the weight percent added dry strength agent, the labels are positioned below the marker for CMF gen1, above the marker for PAA CNF and to the left of the marker for PAA fibre.

The sheets with holocellulose fibres had significantly higher strength than e.g. refined SBK at the same level of density.

The sheet structure will be consolidated during wet web formation, pressing and drying, as the web consolidates fibre-fibre interaction increases which strengthens the network. The largest increase in the dry strength for the fibre network is attributed to the removal of water in the drying process. The forces acting on the fibres during the drying helps to facilitate fibre-fibre joints to form and develop strength to the network but also causes it to shrink and can lead to visible defects. The sheet with highly refined SBK had high strength (101 kNm/kg) but also visible defects from the drying process. However, the sheet with 100% PAA fibres had higher strength (120 kNm/kg) compared to highly refined SBK and no visible defects. A possible explanation is that the PAA fibres collapse to a higher degree in the pressing, increasing the dry content after the press and improving fibre-fibre interaction in the wet web. Lower dry content in the wet web after the press could potentially decrease the forces acting on the sheet during drying and enable the formation of a more rigid fibre network with higher resistance towards deformation.

FIG. 12 shows the tensile strength vs the final sheet density for laboratory sheets with recycled fibres and added PAA fibre, PAA CNF, CMF gen1 or CS. The sheets were produced with closed white water system and 200 g/ton CPAM and 4000 g/ton bentonite. The PAA CNF was produced from never dried (ND) or once dried (OD) PAA fibres. The data labels are the weight percent added dry strength agent, the labels are positioned to the left of the markers for PAA fibre and PAA CNF (OD), and to the right of the marker for PAA CNF (ND), CMF gen1 and CS.

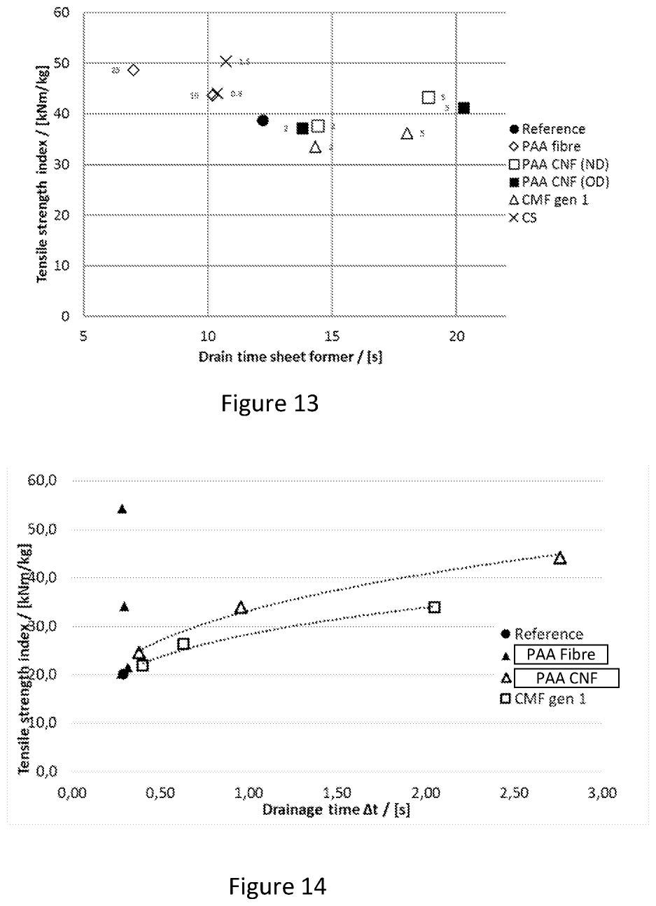

FIG. 13 shows the tensile strength vs the drain time in the sheet former for laboratory sheets with recycled fibres and added PAA fibre, PAA CNF, CMF gen1 or CS. The sheets were produced with closed white water system and 200 g/ton CPAM and 4000 g/ton bentonite. The PAA CNF was produced from never dried (ND) or once dried (OD) PAA fibres. The data labels are the weight percent added dry strength agent, the labels are positioned to the left of the markers for PAA fibre and PAA CNF (OD), and to the right of the marker for PAA CNF (ND), CMF gen1 and CS.

FIG. 14 shows that the addition of 25 or 50 wt % of holocellulose fibres increases the tensile strength by 75% or 150%, but does not impair the dewatering. It can be also seen that sheets with CNF from holocellulose fibres obtain a better strengthening effect at a given drainage compared to CMF gen1; or a better dewatering at a given strength level.

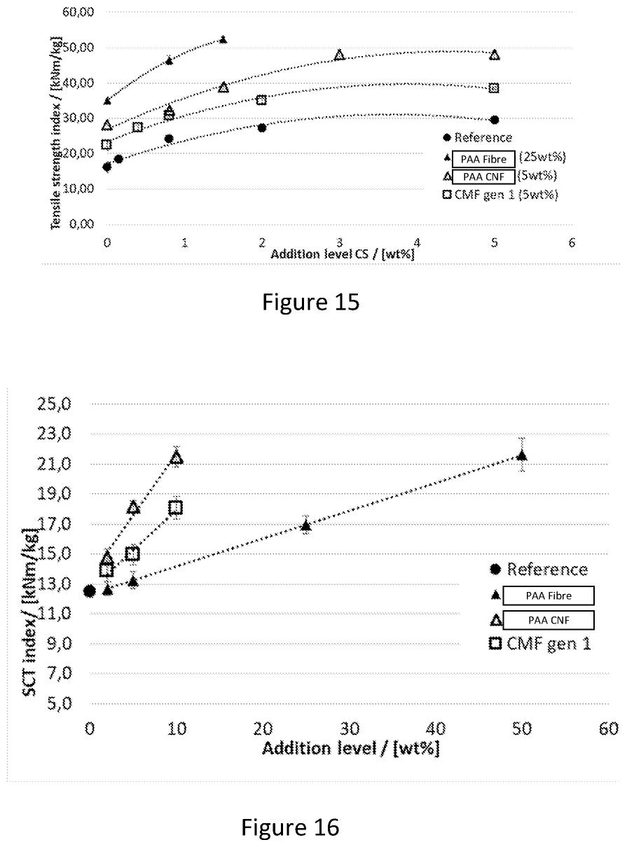

FIG. 15 shows that holocellulose fibres (PAA fibres) in an amount of 25% by weight of the fibres together with cationic starch (CS) added in an amount of 1% by weight and 1.5% by weight, based on the dry content of the stock, provide for a synergistic effect with respect to improved tensile strength at already low starch addition levels.

FIG. 16 shows SCT index for sheets produced with recirculating white water. It can be seen that the development in SCT with addition of the holocellulose fibres in an amount from 2 to 50% by weight, based on the dry content of the stock, followed the same trend as the tensile strength.

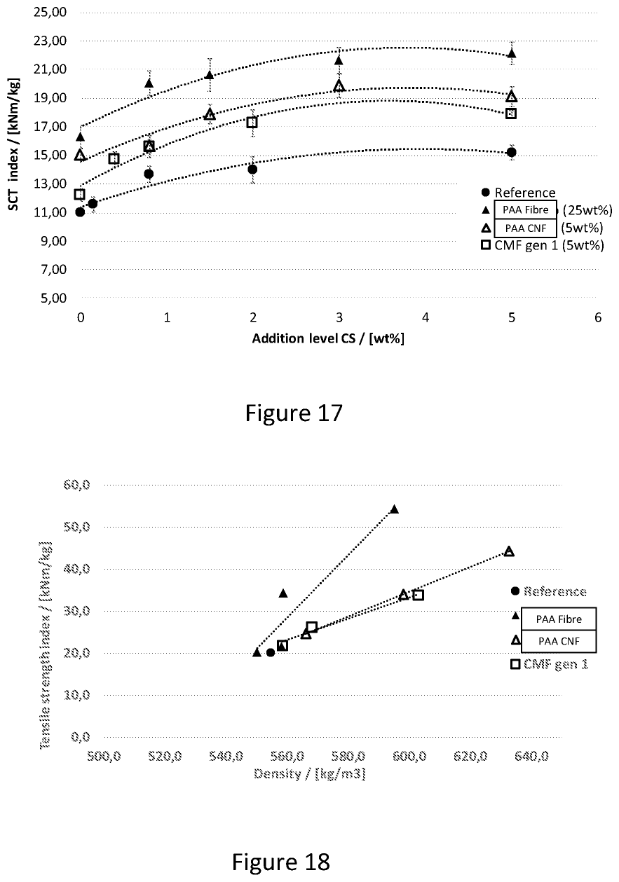

FIG. 17 shows SCT index for sheets formed with holocellulose fibres in an amount of 25% by weight and cationic starch in amounts from 0.5-5% by weight, both based on the dry content of the stock. It can be seen that the development in SCT with addition of holocellulose fibres and cationic starch followed the same trend as the tensile strength.

FIG. 18 shows that the holocellulose fibres develop strength at a lower rate of densification.

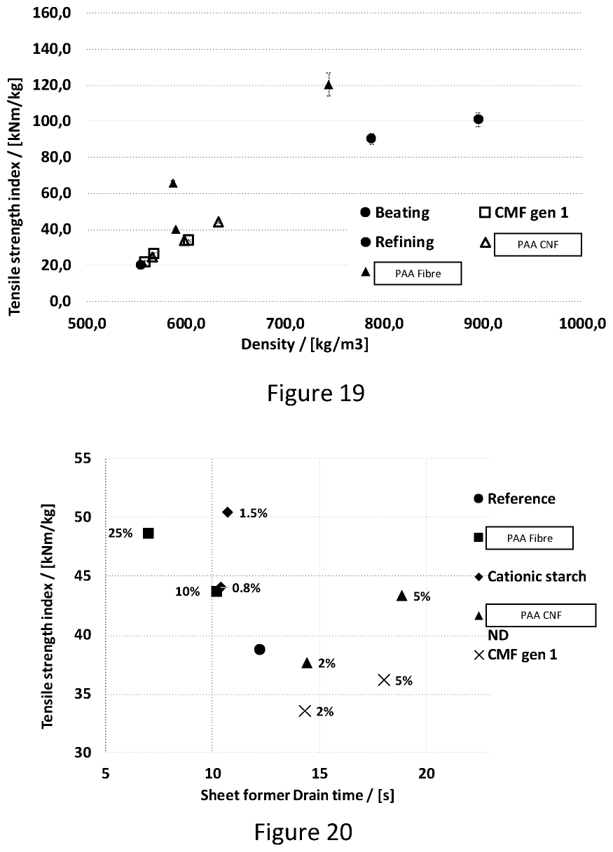

FIG. 19 shows that addition of holocellulose fibres give a better strength with less densification compared to refining (Beating: 199, 399 kWh/t; SR 24 & 63).

FIG. 20 shows that addition of holocellulose fibres to recycled fibres (OCC) improves the tensile strength and the dewatering significantly. It can be seen however, that CNF from holocellulose also improves strength, but less than the holocellulose fibres.

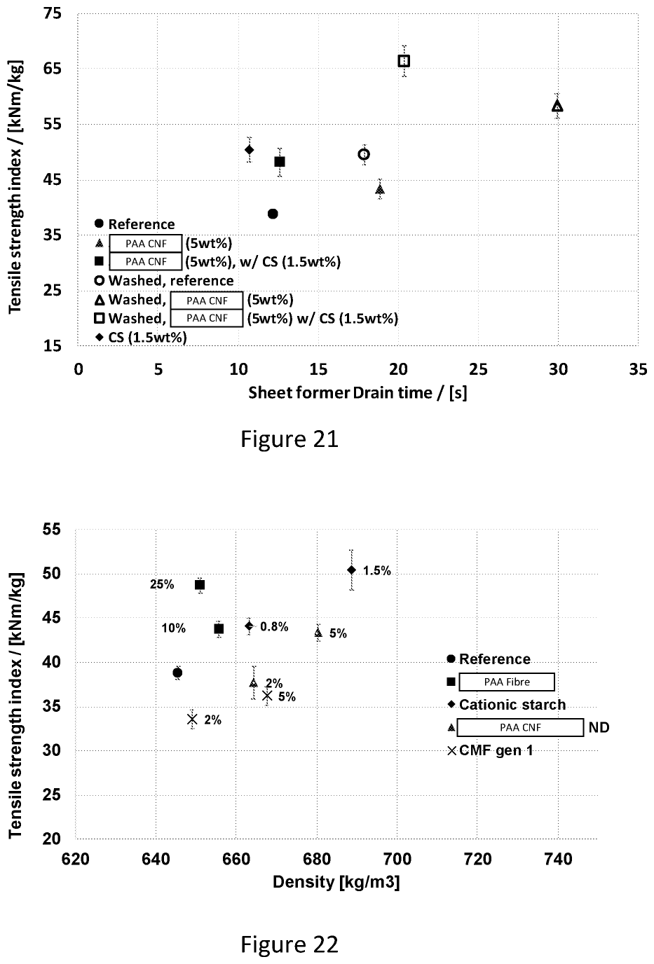

FIG. 21 shows that by washing the RF fibres in the form of OCC (i.e. by removal of filler and fine material from the OCC), holocellulose CNF gives significant improvements in strength.

FIG. 22 shows that there is little densification observed with addition of holocellulose fibres. Addition of holocellulose CNF gives significant strength improvement but with some densification.

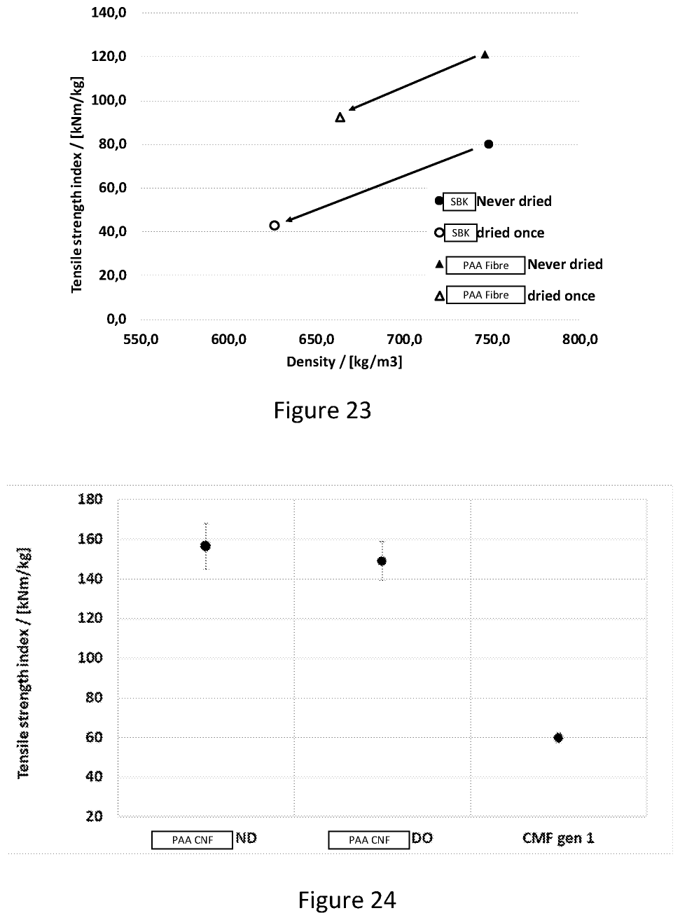

FIG. 23 shows the effect of drying holocellulose fibres. It can be concluded that there seems to be no essential hornification of the fibres, and thereby no essential loss of strength when the fibres are dried. This can be seen when the effect is compared between the holocellulose and SBK fibres.

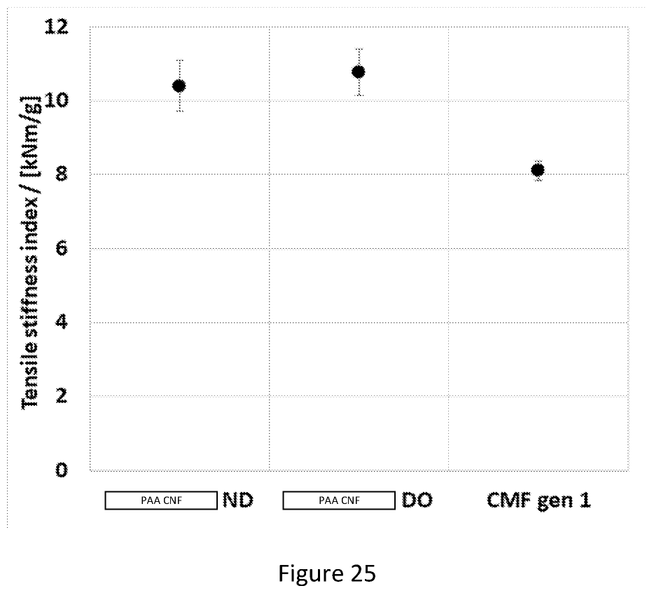

Additionally, CNF films were produced and tensile strength and stiffness of the films were measured after drying. From FIGS. 24 and 25 it can be seen that better results are obtained by the holocellulose-based CNF compared to CMF gen 1.

### Examples—Holocellulose Fibre Production

All the experiments were conducted in glass reactors, with internal recirculation of the effluent, temperature control (via circulation of a heated fluid in an envelope), and pH adjustment via on-demand injection of caustic soda. Some experiments referred to as “with continuous injection” also had a continuous injection of peracetic acid, consisting of a pump, injecting continuously peracetic acid at preprogramed paces. In some cases, the caustic soda injection was also programmed, at values of about 0.26 mL/min of a caustic soda solution of 30%.

All the experiments ended before defibration with an extra washing procedure comprising the following steps: an alkaline step, in which liquor to wood ratio was approximately 7.5 with an initial pH of 12 and an end pH above 10, at a room temperature of about 20° C., the duration was from 30 to 60 minutes, and three water washes, 10 to 20 minutes each, with a liquor to wood ratio of around 7.5.

The measurements were made in a similar manner as described above in the previous experimental section starting on page 20.

Reference Pulp

The reference pulp is referred to as SD.BV.16 and was produced with only 2 consecutive peracetic acid stages, where all the peracetic acid was charged to the reactor from the beginning of the reaction. This batch of 130 g of wood in small chips involved a first peracetic step with 88 g of peracetic acid, in about 975 g of water, and constant pH adjustment with sodium hydroxide was made to a pH value of 4 to 4.40. The temperature was increased gradually from 21 to 84 degrees Celsius during 5 hours of the reaction. The liquid phase was then removed from the reactor. Another peracetic acid solution was then added to the reactor (including 88 g of pure peracetic acid, 780 g of water, and caustic soda for pH adjustment) and pH was kept between pH 4 and 4.35 with an on-demand caustic soda addition. The temperature increased from 21 to 78 degrees during the 4.5 hours of the reaction. A washing procedure involving water and caustic soda was then started. A total of 1.36 g (PAA) per g (wood) was charged to the reactor.

Pulps According to the Present Disclosure

SD.BV.06, Continuous PAA Addition

Sample SD.BV.06 was carried out on 90 grams of wood chips of the same size as used in the production of reference pulp SD.BV.16, and involved only one peracetic acid stage with continuous injection. The wood was placed in a reactor with double envelope for temperature control. The temperature was set at 80 C. pH was adjusted with an injection of caustic soda to keep the pH value between pH 4 and 4.35. The peracetic acid injection was set so that the peracetic acid concentration would not go over 3% in the reactor. The injection speed was carried out with a Harvard pump, with a speed set at 100 mL per hour. The peracetic acid supply was distilled peracetic acid at 40%. In SD.BV.06, 0.98 g (PAA) per g (wood) was consumed.

SD.BV.07, Continuous PAA Addition

Sample SD.BV.07 is in its design a duplicate of SD.BV.06 carried out at a lower temperature. 90 g of wood was put in the reactor containing 675 mL of water, and kept at 60° C. A total of 157.9 mL of a mother solution of peracetic acid was continuously injected at a speed of 50 mL/h. The total charge of peracetic acid used in this experiment is of 0.75 g (PAA)/g (wood). The reaction time was about 6 h and 25 minutes.

SD.BV.05b, Two-Step PAA-Addition with an Intermediate Alkaline Step

Sample SD.BV.05b was carried out on 90 g of wood chips of the same size as used in the production of reference pulp SD.BV.16, with a first conventional peracetic acid stage, in which 63 g (expressed as pure peracetic acid) of peracetic acid was added from the beginning of the treatment (164 mL at 39%), in around 825 mL of water. The amount of caustic soda added through the experiment was to keep the pH around pH 4.3 and was of 55 mL of a solution having a concentration of 30%. The alkaline treatment following the peracetic acid stage was carried out without prewashing the pulp, and with an initial pH of 12 at a temperature of 60° C., with a liquor to wood ratio of 6. The pH was set to evolve freely. The treatment was followed by a second peracetic acid treatment, similar to the first one: 164 mL of peracetic acid injected from the beginning, 660 mL of water, and a total of 55 mL of caustic soda to keep the pH at the target value. The second peracetic acid stage was considered to be over when the wood was considered white enough to be defibered easily. The first peracetic acid treatment step was stopped with a low residual concentration. A calculated amount of 0.60 g (pure PAA)/g of wood was consumed. The second peracetic acid treatment step was considered over with a residual peracetic acid quantity, giving a consumption value of 0.5 g of peracetic acid per/g of wood. The total consumption in this experiment was then 1.1 g (PAA)/g (wood).

SD.BV.12, Two-Step PAA-Addition with an Intermediate Alkaline Step

SD.BV.12 is inspired from SD.BV.05b. It comprises a first peracetic acid step (110 g of wood of wood chips of the same size as used in the production of reference pulp SD.BV.16), in 825 mL of water, and an initial charge of 165 mL of a 39% peracetic acid solution, with pH adjustment at around 4.3 with 30% caustic soda). This step is followed by a wash with water (10 minutes, 825 mL). An alkaline treatment is then carried out (initial pH of 12, with pH adjustment to keep the pH above 10, 1.1 L of water) for 1 hours at room temperature (25-30 degrees). The wood is then washed with water (3 consecutive washes with 650 mL of water). The wood then undergoes a peracetic acid treatment (660 mL of water, initial charge of 165 mL of peracetic acid, pH adjustment with caustic soda when necessary to keep the pH at 4.3). The last peracetic acid stage was considered as over when the wood was considered as sufficiently white to be easily defibred. At that point, a residual peracetic acid concentration was measured. The total quantity of peracetic acid consumed to produce this material is 0.98 g (PAA)/g (wood).

SD.BV.14, Two-Step PAA-Addition with Continuous Charge and an Intermediate Alkaline Step

SD.BV.14 is an experiment combining the idea of a continuous charge of the peracetic acid with the idea of having an intermediate alkaline treatment between two PAA steps. The experiment went as follows. A first peracetic acid treatment step (150 g of wood of wood chips of the same size as used in the production of reference pulp SD.BV.16) was carried out at 60 degrees Celsius with continuous caustic soda injection (to keep the pH at a target of approximately 4.3), and continuous injection of peracetic acid (mother solution at 39%, for a total volume injected of 90 g). The injection speed was designed to be fast during the first 15 minutes to increase the concentration in the medium to around 3% (speed around 60 mL/min), and slow during the next 3 hours (20 mL/h). The wood is then washed during 10 minutes with water. The reactor is flushed, and an alkaline treatment is then carried out, with 1.1 L of water, and of a concentrated caustic soda (30%) solution to bring the pH in the reactor at a value of above pH 10 for one hour at room temperature (around 25° C.). Wood is then washed with tap water. After washing a second peracetic acid treatment begins, with 850 mL of water, at 60° C., pH control and adjustment to have a value of pH 4.3 (with a caustic soda solution at 30%) and a first quick injection of peracetic acid (13.16 mL in 15 minutes of a solution at 39%) to quickly raise the concentration in the reactor, followed by a second slower injection of peracetic acid (24 mL/h) until the total peracetic acid has been injected (around 150 mL). The sample is then washed. The total charged peracetic acid is of 0.68 g(PAA)/g (wood).

Results

Experiments prove that the method of producing holocellulose fibres according to the present disclosure is efficient and the consumption of organic peroxide, in this case PAA, can be reduced.

The two-step treatment with organic peroxide, which can be peracetic acid, with an intermediate alkaline step pertains to improving the efficiency of peracetic acid during delignification through the removal of some of the dissolved lignin, and through the solubility under alkaline conditions of partly oxidized lignin. The removal of those two lignin fractions leads to a decrease of the peracetic acid need to obtain a certain degree of lignin removal, as illustrated in FIG. 27, in which the PAA consumption of the reference, SD.BV.05B and SD. BV.12 pulps were compared. FIG. 27 illustrates the consumption of peracetic acid per gram of wood given in arbitrary units in the method comprising the two-step PAA-addition with an intermediate alkaline step. On the left the reference, in the middle the exact same experiment with continuous injection (SD.BV.05B), on the right an experiment with continuous injection at a lower temperature (SD.BV.12). A reduction of 20% and of 28% were respectively obtained.

In FIG. 28 the consumption of peracetic acid per gram of wood given in arbitrary units in the method comprising continuous PAA addition. On the left the reference, in the middle the same experiment with continuous injection (SD.BV.06), on the right an experiment with continuous injection at a lower temperature (SD.BV.07). A reduction of 28% and of 45% were respectively obtained.

Thus, the theory of chemical kinetics is in line with the findings in these experiments. Additionally, the pulp prepared via a continuous injection of peracetic acid displayed properties similar to the ones observed for the pulps treated under conditions involving the use of peracetic acid (PAA) in an amount of 2.5 g PAA/g fibres.

It has been additionally noted that the alkaline treatment enables the control of the cellulose ultrastructure. The alkaline extraction seems to be able to modify heavily the cellulose ultrastructure, by directly affecting the size of the cellulose fibril aggregates (LFAD: Lateral fibril aggregate dimension), without modifying neither the chemical composition (carbohydrate analysis) nor the mechanical properties (displayed in papermaking). However, the control of this parameter is not mastered entirely, but the alkaline stage seems to play a key role in this change.

FIG. 29 illustrates the chemical composition of samples SD.BV.05b (illustrating the alkaline treatment without pH control and separating 2 PAA stages), SD.BV.12 (illustrating the same concept with pH control) and SD.BV.16 (reference). SD.BV.16 was obtained with several consecutive conventional peracetic acid stages. SD.BV.05b was obtained after one conventional peracetic acid treatment, followed by an alkaline treatment (start pH 12, room temperature, 1 h), followed by another peracetic acid treatment. The main change between SD.BV.16 and SD.BV.05b is the added extraction stage in SD.BV.05b. This change also resulted in a lower total peracetic acid consumption (See FIG. 27).

Table 4 below shows measured values for the different pulps. Reference samples give LFAD values of about 20 nm, when a pulp treated with this invention gives a value of 30.9 nm. This value is of the outmost importance since the development of the macro-scale mechanical properties is currently believed to be in direct link to the cellulose fibril aggregate size. SD.BV.16 is the reference, SD.BV.05b is the one with unusual LFAD.

TABLE 4

| | | | “X-ray” | LFAD | | | Average | Total | Surface | |
|---|---|---|---|---|---|---|---|---|---|---|
| Cooking | LFD | LFAD | Cry | ssa | FSP | WRV | pore size | charge | charge | Ratio |
| Process | (nm) | (nm) | (%) | (m2/g) | (g/g) | (g/g) | (2t) (nm) | [μeq/g] | [μeq/g] | (surface/total) |
| SD.BV.16 | 3.2 | 20.8 | 41% | 128 | 1.88 | 2.00 | 29.3 | 255 | 45 | 18% |
| SD.BV.5b | 3.1 | 30.9 | 40% | 86 | 1.35 | 1.88 | 31.3 | 212 | 65 | 31% |
| SD.BV.7 | 3.1 | 20.2 | 40% | 132 | | 1.74 | | — | — | — |
| SD.BV.14 | 3.2 | 18.0 | 42% | 148 | 2.12 | 1.76 | 28.7 | 218 | 28 | 13% |
| Kraft | 4.0-5.2 | 21 | | 122 | 1.42 | 1.49 | 23.3 | 48 | 3 | 6.25% |

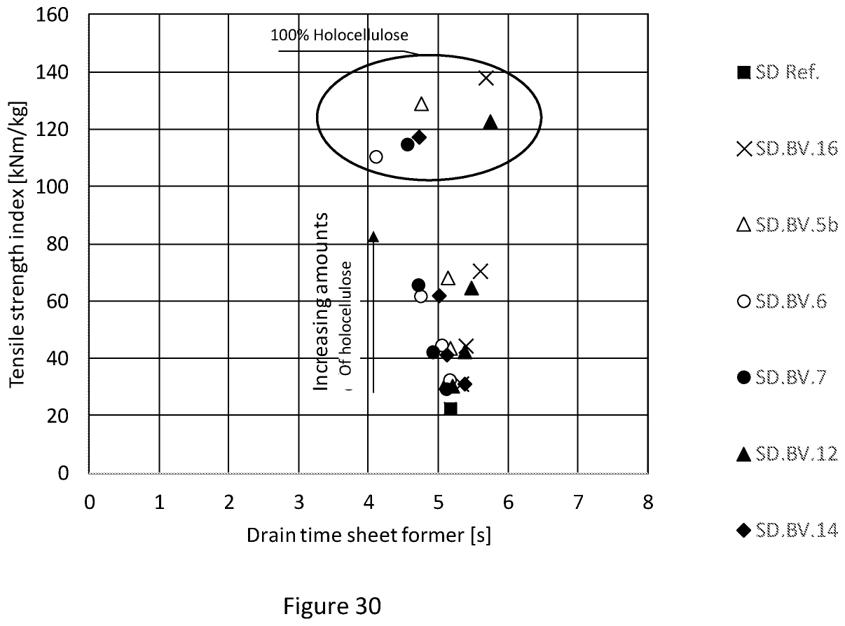

FIG. 30 illustrates a drain time in a sheet former as a function of increasing tensile strength index in (kNm/kg) and as a function of increasing amount of holocellulose fibres in the pulp. It can be seen that by using the holocellulose fibres obtained by the present production method in which less PAA is used than in the known methods, the strength was substantially increased while the draining time was not substantially increased. It should be noted that the reference SD is a commercial pulp not containing holocellulose fibres.

The description above and the examples are provided to further illustrate the features and advantages of the present invention. However, the scope of the invention is defined by the appended claims.

1. A method of producing holocellulose fibres useable in a process for the production of paper by treating a wood-based raw material with an organic peroxide, wherein the method comprises:
i. charging the organic peroxide continuously to the wood-based raw material during the treatment; and/or
ii. charging the organic peroxide to the wood-based raw material in at least two separate steps with an intermediate alkaline treatment step.

2. The method according to claim 1, wherein the intermediate alkaline treatment step is performed at a pH of pH 8 or more, or from pH 10-12, a temperature of 15-100° C. at atmospheric pressure, and for a duration of at least 1 hour.

3. The method according to claim 1, wherein in at least one of the at least two separate steps of organic peroxide treatment, the organic peroxide is charged batchwise or continuously to the wood-based raw-material during the treatment.

4. The method according to n claim 1, wherein the organic peroxide treatment is performed at a temperature of 40 to 90° C. or 55 to 75° C.

5. The method according to claim 1, wherein the organic peroxide treatment is performed at a pH of 2.5 to 5 or 4.0 to 4.8.

6. The method according to claim 1, wherein the continuous charging is performed at one or more charge rates during the whole treatment.

7. A method of producing a paper strength agent useable in a process for the production of paper comprising producing holocellulose fibres according to the method of claim 1, optionally microfibrillating the holocellulose fibres to provide holocellulose nanofibrils (CNF), drying the holocellulose fibres or the holocellulose nanofibrils and reslushing the dried holocellulose fibres or the holocellulose nanofibrils.

8. A process for the production of paper comprising the steps of:
a. preparing a papermaking stock comprising an aqueous pulp slurry comprising cellulosic fibres and having a fibre consistency of from 0.1 to 40% by weight, wherein the cellulosic fibres comprise wood-based holocellulose fibres, and wherein the amount of the wood-based holocellulose fibres is from 0.5 to 100% by weight, based on the total weight of the cellulosic fibres,
b. providing the stock to a wire and form a web,
c. dewatering the web, and
d. drying the web.

9. The process according to claim 8, wherein the wood-based holocellulose fibres are produced by treating a wood-based raw material with an organic peroxide, preferably peracetic acid (PAA).

10. (canceled)

11. The process according to claim 8, wherein the wood-based raw material for the holocellulose fibres comprises hardwood and/or softwood material.

12. The process according to claim 8, wherein the holocellulose fibres are added after a refining step in the step a) of preparing the stock.

13. The process according to claim 8, wherein the step a) of preparing the papermaking stock comprises a step of adding to the aqueous slurry an additive, beating and/or refining the aqueous slurry.

14. The process according to claim 13, wherein the additive comprises the holocellulose fibres which are added in an amount of 0.5 to 80% by weight, or from 2 to 60% by weight or from 4 to 55% by weight, based on the dry weight of the cellulosic fibres.

15. The process according to claim 13, wherein the additive comprises a dry strength agent chosen from nanocellulosic materials, charged and non-charged starch, gum derivatives, synthetic copolymers with acrylamide and combinations thereof.

16. The process according to claim 13, wherein the additive comprises a cationic starch added in an amount of 0.5 to 5% by weight, based on the dry weight of the cellulosic fibres.

17. (canceled)

18. The process according to claim 13, wherein the additive comprises a holocellulose CNF added in an amount of 0.1 to 10% by weight, or from 0.5 to 5% by weight, based on the dry weight of the stock.

19. (canceled)

20. The process according to claim 13, wherein the additive comprises a wet strength agent, which is a resin chosen from urea-formaldehyde resins, melamine-formaldehyde resins, polyamide-amine-epichlorohydrine resins and combinations thereof.

21. The process according to claim 13, wherein the additive comprises a retention aid chosen from charged or non-charged polyacrylamide (PAM), polyethyleneimine (PEI), colloidal silica (CS), bentonite, and combinations thereof.

22. The process according to claim 13, wherein the additive is cationic polyacrylamide (CPAM).

23. The process according to claim 8, wherein the cellulosic fibres comprise fibres from a kraft pulp, soda pulp, sulfite pulp, mechanical pulp, thermomechanical pulp, semi-chemical or chemi-thermomechanical pulp, recycled pulp or mixtures thereof in an amount of from 0-99.5% by weight, based on the total weight of the cellulosic fibres.

24-27. (canceled)
